(19) United States
(12) Patent Application Publication
(10) Pub. No.: US 2019/0147515 A1
(43) Pub. Date: May 16, 2019

(54) FACILITATING TRANSACTIONS USING TRANSACTION TOKENS

(71) Applicant: Facebook, Inc., Menlo Park, CA (US)

(72) Inventors: Kevin Patrick Hurley, Menlo Park, CA (US); Yegnashankar Parasuram, Cupertino, CA (US); Gary Eugene Baalman, San Jose, CA (US); Vladislav Perelman, Mountain View, CA (US)

(21) Appl. No.: 15/809,949

(22) Filed: Nov. 10, 2017

(51) Int. Cl. G06Q 30/06; G06Q 20/36; G06Q 20/40; H04L 29/06; H04L 9/32

(52) U.S. Cl. CPC G06Q 30/0613; G06Q 20/3674; H04L 9/3213; H04L 63/08; G06Q 20/40

(57) ABSTRACT

Methods, systems, and computer readable storage media are disclosed for facilitating a payment transaction between a user and a merchant. In particular, one or more embodiments call a third-party tokenization system in response to a request to initiate the payment transaction to obtain a payment token representing a payment authorization number. Additionally, one or more embodiments wrap the payment token within a transaction token to send to a merchant system associated with the merchant. One or more embodiments receive the transaction token in connection with a request to process the payment transaction and then extract the payment token based on receiving the transaction token. One or more embodiments then initiate the payment transaction based on receiving the transaction token by sending the payment token to a payment network.

### BACKGROUND AND RELEVANT ART

Electronic payment systems allow users to perform payment transactions with others via software applications on one or more types of devices (e.g., desktop devices and mobile devices). Some electronic payment systems allow users to perform payment transactions with financial institutions or merchants (i.e., peer-to-business payment transactions). For example, some electronic payment systems allow users to enter into payment transactions for goods or services with a merchant by way of an electronic payment application or a web browser on a computing device.

Some conventional electronic payment systems provide secure payment transactions by implementing tokenization of payment credentials to prevent sensitive information from being exposed to other parties. For example, some conventional systems integrate with a payment gateway system (such as BrainTree) to obtain gateway payment tokens for processing payment transactions via the specific gateway system. Payment tokens allow users to initiate payment transactions with merchants without allowing merchants or others to obtain and view the payment credentials (e.g., a credit card number).

While gateway payment tokens provide a convenient way for users to quickly engage in secure payment transactions with merchants, gateway payment tokens are typically only valid for a specific merchant and payment gateway combination. In particular, the merchant sets up the relationship with the payment gateway and controls when gateway payments tokens are used (merchants typically do so to avoid storing credit card information and dealing with PCI compliance rules).

Additionally, gateway payment tokens are typically valid for a very short time window after the payment gateway provides the gateway payment tokens for use in a payment transaction. By limiting the gateway payment tokens to a small time window immediately after the tokens are requested, the conventional systems attempt to reduce the risk of the tokens being compromised. Accordingly, a merchant must process the payment transaction within the short time window after receiving the request by a consumer to purchase a good or service. Because the gateway payment tokens are limited to such a short time period, gateway payment tokens may not provide for variability or flexibility in the structure of the payment transactions.

Furthermore, while conventional systems may use gateway payment tokens or other types of tokens (e.g., network payment tokens, third-party payment tokens, or single-use payment tokens) to process payment transactions, each of the payment tokens provides certain advantages and disadvantages relative to the other types of payment tokens. For example, using different gateways and/or different types of tokens across a plurality of payment transactions involving different users and merchants can result in a variety of different integrations required of the merchants. Additionally, conventional systems cannot track the status and use of each payment token with a high level of specificity throughout the entire transaction process due to the inherent limitations of, and the different processes for, each type of payment token. Thus, conventional systems can introduce complexity and inflexibility into the merchant experience.

### BRIEF SUMMARY OF THE INVENTION

One or more embodiments provide benefits and/or solve one or more of the foregoing or other problems in the art with systems, methods, and computer readable storage media for providing consistent and secure commerce payment processes for merchants. In particular, in one or more embodiments, a disclosed system provides a consistent interface for merchants integrating with a payment system using transaction tokens for the payment transactions. The disclosed system calls a third-party tokenization system to obtain a payment token representing a payment authorization number for the payment transaction and then wraps the payment token within a transaction token. Accordingly, the disclosed system can wrap any kind of payment token within a transaction token to provide consistent merchant interfaces/interactions in connection with a payment transaction process.

Furthermore, after wrapping the payment token within the transaction token, the disclosed system can send the transaction token to a merchant system for later use by the merchant system. Specifically, when the merchant system wants to initiate the payment transaction, the merchant system returns the transaction token to the disclosed system. The disclosed system can then use extract the payment token from the transaction token and initiate the payment transaction by sending the payment token to a payment network for processing the payment transaction. Additionally, the disclosed system can scope the transaction token to a specific merchant, payment amount, and a time period for which the transaction token is valid. Thus, the disclosed system can manage the use of the payment token and track the payment token by wrapping the payment token within the transaction token and limiting the scope of the transaction token. In alternative embodiments, the transaction token is not scoped.

Additional features and advantages of one or more embodiments of the present disclosure will be set forth in the description which follows, and in part will be obvious from the description, or may be learned by the practice of such example embodiments.

### BRIEF DESCRIPTION OF THE DRAWINGS

Various embodiments will be described and explained with additional specificity and detail through the use of the accompanying drawings in which:

FIG. 1 illustrates a schematic diagram of a system for facilitating a purchase using a commerce application in accordance with one or more embodiments;

FIGS. 2A-2B illustrate a sequence-flow diagram illustrating interactions between the commerce application, network application, and payment network of FIG. 2 in accordance with one or more embodiments;

FIGS. 3A-3F illustrate user interfaces for completing a financial transaction using a commerce application in accordance with one or more embodiments;

FIG. 4 illustrates a flowchart of a series of acts in a method of facilitating a payment transaction between a user and merchant in accordance with one or more embodiments;

FIG. 5 illustrates a detailed schematic diagram of the system of FIG. 1 in which an e-commerce application operates in accordance with one or more embodiments;

FIG. 6 illustrates a block diagram of an exemplary computing device in accordance with one or more embodiments;

FIG. 7 illustrates an example network environment of a social networking system in accordance with one or more embodiments; and

FIG. 8 illustrates an example social graph for a social networking system in accordance with one or more embodiments.

### DETAILED DESCRIPTION

One or more embodiments of the present disclosure include an e-commerce payment facilitator that acts as an intermediary between a commerce application and a payment network. Specifically, the e-commerce payment facilitator uses transaction tokens when communicating with commerce applications and for tracking the use of payment tokens. For example, when a commerce application associated with a merchant system sends a request to the e-commerce payment facilitator to initiate a payment transaction, the e-commerce payment facilitator wraps a payment token for the requesting user within a transaction token and scopes the token to the transaction using specific criteria. The commerce application can then pass the transaction token back to the e-commerce payment facilitator to authenticate and initiate the payment transaction with the payment token referenced by the transaction token.

In one or more embodiments, the e-commerce payment facilitator allows one or more merchants to communicate with the e-commerce payment facilitator for processing payment transactions between the merchants and consumers. In particular, a merchant system associated with a merchant can integrate with the e-commerce payment facilitator (e.g., using an application programming interface) to use the e-commerce payment facilitator as an intermediary between the merchant system and a payment network associated with the merchant system to process payment transactions. For example, the e-commerce payment facilitator can allow merchant systems to integrate via a social networking website or merchant websites. Thus, the e-commerce payment facilitator can integrate with a plurality of separate merchant systems and provide flexibility to the merchant systems in how the merchant systems provide products to consumers.

Additionally, the e-commerce payment facilitator communicates with one or more third-party tokenization systems to obtain payment tokens for use in payment transactions. Specifically, the third-party tokenization systems can include entities that provide the ability for consumers to engage in secure electronic payment transactions to purchase goods or services from merchants. For example, a third-party tokenization system determines a payment authorization number for a consumer to be used in a payment transaction and then tokenizes the payment authorization number. The third-party tokenization system sends the tokenized payment authorization number (i.e., a payment token) to the e-commerce payment facilitator.

In response to receiving the payment token from the third-party tokenization system, the e-commerce payment facilitator wraps the payment token within a transaction token to send to the merchant system (e.g., via the commerce application). In particular, the e-commerce payment facilitator can generate the transaction token to include information that allows the e-commerce payment facilitator to identify the specific payment transaction and the payment token. The e-commerce payment facilitator can then track the use of the transaction token throughout the transaction process. For instance, the e-commerce payment facilitator can track when the transaction token is passed to a merchant backend or a client device and then when a transaction is initiated/authorized (i.e., when the transaction token is received back from the merchant backend or client device). This contrasts with the use of only payment tokens in which an e-commerce payment facilitator can track when the payment token is passed to the merchant backend or client device but not when the transaction is initiated/authorized.

In one or more embodiments, when the merchant system returns the transaction token to the e-commerce payment facilitator to initiate the payment transaction, the e-commerce payment facilitator extracts the relevant information based on the transaction token. For example, the transaction token access the payment token and other transaction information for processing the payment transaction that is mapped to the transaction token. The e-commerce payment facilitator then initiates the payment transaction using the information extracted using the transaction token by sending the information to the payment network.

Additionally, the e-commerce payment facilitator can scope the transaction token using one or more criteria to limit the use of the transaction token. For instance, the e-commerce payment facilitator can scope the transaction to a specific use (e.g., a payment amount for a transaction involving the merchant system) at a specific time (e.g., a present or future time). Thus, the e-commerce payment facilitator can limit the use of the payment token to only the payment transaction for which the transaction is scoped with the merchant system, for the payment amount indicated in the payment transaction request, and within a time period indicated.

By wrapping a payment token within a transaction token for a payment transaction, the e-commerce payment facilitator is able to provide increased security and tracking capabilities for a payment transaction process. Indeed, by wrapping the payment token within a transaction token, the e-commerce payment facilitator can provide the payment token to the merchant system with a common integration experience regardless of the type of payment token. For example, the e-commerce payment facilitator can wrap a gateway payment token, a network payment token, or a third-party payment token within the transaction token and provide the same integration interface to the merchant system. Thus, regardless of the type of payment token a merchant system uses, the merchant system still uses the same process and interface with the e-commerce payment facilitator. Accordingly, the e-commerce payment facilitator can provide consistent integration processes and payment processes for a plurality of merchant systems, in addition to security features that may not have otherwise been available for all payment token types.

Furthermore, scoping a transaction token (and therefore the payment token within the transaction token) based on a plurality of criteria limits allows for further security for a payment transaction. In particular, conventional payment tokens allow for scoping or limiting the use of the payment token. However, conventional payment tokens typically lack the capability to provide one or more types of scoping. The transaction token, on the other hand, provides the capability to provide all types of scoping. Thus, the use of the transaction token can provide for a type of scoping not available to a payment token wrapped by the transaction token.

For example, in one or more embodiments, the e-commerce payment facilitator can scope the transaction token relative to a first transaction variable/characteristic that differs from a second transaction variable/characteristic to which the payment token is scoped. For example, typically third-party tokens can be scoped to an amount but not a merchant. Thus, when using a third-party token as a payment token, the e-commerce facilitator can scope the transaction token to a specific merchant to further increase transaction security. Similarly, typically network payment tokens may are not scoped to an amount. Thus, when using a network token as a payment token, the e-commerce facilitator can scope the transaction token to a specific amount to further increase transaction security.

By scoping the transaction token to a specific merchant, to a payment amount associated with the payment transaction, to a specific time period, a time-to-live, etc., the e-commerce payment facilitator ensures that the payment transaction within the transaction token can only be used to perform the specific payment transaction. Even if a malicious entity obtained the transaction token, the malicious entity would only be able to use the payment token for the purpose of completing the payment transaction. Therefore, the e-commerce payment facilitator can provide a secure payment transaction process by reducing the number of entities that can access the payment token and limiting the use of the payment token to the explicitly identified payment transaction.

The transaction token also allows a merchant system to use the transaction token at a later date. Specifically, scoping the payment token within the transaction token to a future time period allows for a delayed payment transaction that accounts for typical delays in processing and completing a purchase order for a product. For example, purchasing a product that the merchant system ships to the consumer can typically require several days to process the purchase order and then ship the purchased product to the user. Accordingly, scoping the payment token to the future time period allows the merchant system to charge the consumer at the time of, or after, shipping the product based on the scoped time period, reducing the need to refund the purchase order, such as if the product is out of stock or a cancellation of the purchase order prior to shipping the product. In contrast, conventional systems typically only provide payment tokens valid for a specific amount of time (e.g., 30 minutes) immediately after providing the payment token.

In addition while the following specification primarily discloses wrapping payment tokens with a transaction token, the present disclosure is not so limited. In particular, in one or more additional embodiments involve wrapping credit cards, debit cards, e-wallets, bank accounts, cash, or other payment instruments with a transaction token to facilitate a common interface, provide increased security, and enable greater transaction tracking.

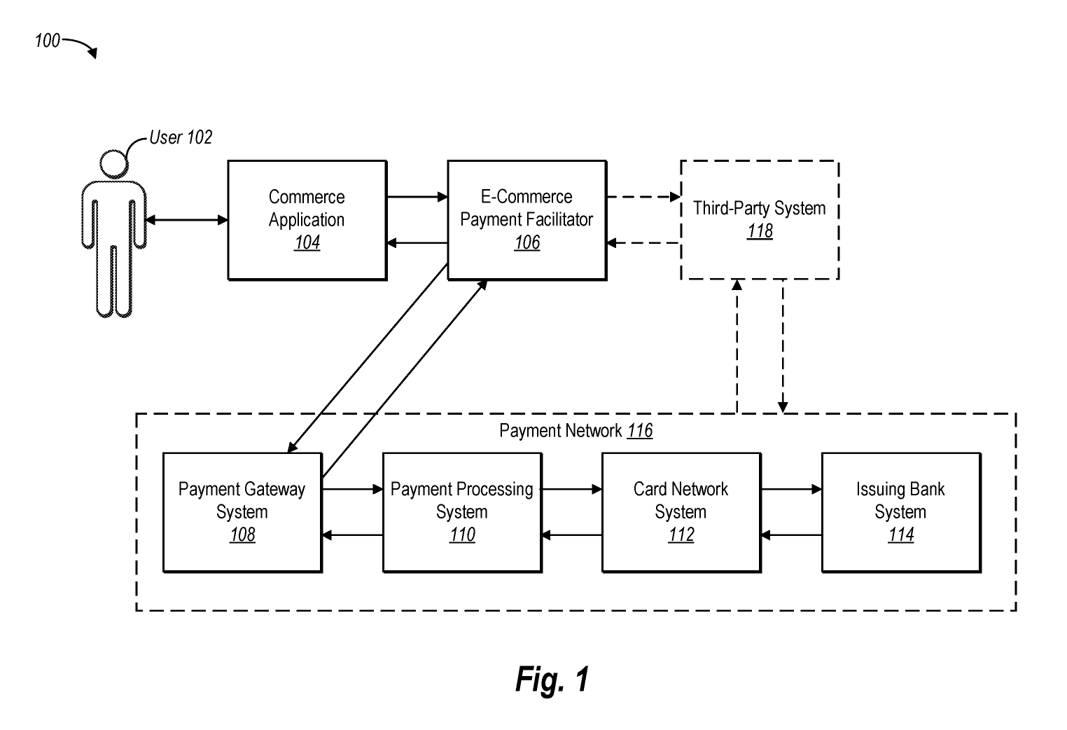

Turning now to the figures, FIG. 1 is a schematic diagram illustrating a system 100 in which an e-commerce payment facilitator operates for performing payment transactions between consumers and merchants. An overview of the system 100 will be described next in relation to FIG. 1. Thereafter, a more detailed description of the components and processes of the system 100 will be described in relation to the remaining FIGS.

As illustrated by FIG. 1, the system 100 can include a user 102, a commerce application 104, an e-commerce payment facilitator 106, a payment network 116, and a third-party system 118. The commerce application can interact with an e-commerce payment facilitator 106 to allow the user 102 to engage in a payment transaction with a merchant. As used herein, the term “payment transaction” refers to an electronic transaction between an exchange of money from one entity to another entity. Specifically, a payment transaction can include a payment from a consumer to a merchant to purchase a product (e.g., a good or service) from the merchant. To complete a payment transaction, the e-commerce payment facilitator 106 can interact with a payment gateway system 108 for the purpose of processing a payment using the payment network 116. The payment network 116 can include a payment gateway system 108, a payment processing system 110, a card network system 112, and an issuing bank system 114. In other embodiments, however, the payment network 116 includes more or fewer actors, though in most embodiments the payment network 116 includes at least a payment gateway system 108. As explained in greater detail below, each component of the system can execute on and/or be implemented by one or more computing devices. As used herein transaction variable or characteristic refers to a characteristic of, or for, a transaction such as a merchant, amount, time frame, amount range, particular items, etc.

The embodiment illustrated in FIG. 1 includes a user 102 accessing a commerce application 104. As explained in greater detail below, the commerce application 104 can comprise a network application, such as a web application or a native application. The commerce application 104 can provide the user 102 with an offer of goods and/or services available from the merchant. Additionally, the commerce application 104 can allow the user 102 to define and enter into a payment transaction with the merchant for the purchase of a product. As will be explained in more detail below, the e-commerce payment facilitator 106 can facilitate a payment transaction by acting as an intermediary between the commerce application 104 and the payment network 116.

When assisting the user 102 in completing a first payment transaction with a merchant via the commerce application 104, the e-commerce payment facilitator 106 can collect information from the user 102. For example, the user 102 can enter payment information into the commerce application 104, such as a name, a payment card (credit card, debit card, etc.) number or payment account number, an expiration date of the payment card, a billing address associated with the payment card, a phone number associated with the payment card, and one or more shipping addresses. The e-commerce payment facilitator 106 can collect the entered information (e.g., in a secure communication) and provide the information to a third-party tokenization system such as the payment gateway system 108 in the payment network 116. In at least some embodiments, the e-commerce payment facilitator 106 is in communication with one or more additional components, such as a tokenization system that is not part of the payment network 116.

As used herein, the term “third-party tokenization system” refers to an entity that stores and/or handles, or has access to an entity that stores and/or handles, payments or payment information for payment transactions and tokenizes payment credentials to create payment tokens. For example, a third-party tokenization system can be associated with a payment provider or other entity that stores or maintains payment accounts or funds for users, such as, but not limited to, a bank (e.g., issuing bank system 114), a credit/debit card issuer (e.g., card network system 112), an entity that manages stored value accounts, or a cash payment provider (e.g., for providing cash payments). Additionally, a third-party tokenization system can include, or be associated with, a payment service that processes payment transactions between users of the payment service by communicating with one or more entities that store or maintain payment accounts or funds. Accordingly, a third-party tokenization system can allow users to register with a service for engaging in peer-to-business payment transactions with other users registered with the service.

In one or more embodiments, the e-commerce payment facilitator 106 calls the third-party tokenization system to obtain a payment token representing a payment authorization number corresponding to the payment transaction. As used herein, the term “payment authorization number” refers to a number that authorizes access to the corresponding payment account. For example, a payment authorization number can be a credit card number, debit card number, gift card number, or cash account number. An issuer of a payment authorization number can include an issuing bank system 114 such as CHASE, BANK OF AMERICA, WELLS FARGO, U.S. BANK, and CITIBANK or a card network system 112 such as VISA, DISCOVER, and MASTERCARD. As used herein, the term “payment token” refers to a tokenized version of a payment authorization number. Specifically, a payment token can include a hashed or otherwise obfuscated version of the payment authorization number that includes a plurality of characters that a payment gateway system 108, a card network system 112, or a third-party system 118 (e.g., a tokenization system external to the e-commerce payment facilitator 106 and payment network 116) maps to the particular payment authorization number for generating gateway payment tokens, network payment tokens, or third-party/one-time use payment tokens, respectively.

As used herein, a network payment token refers to a token obtained from a card network system (e.g., VISA, MASTERCARD, AMEX). Specifically, a network payment token includes a token corresponding to a payment authorization number associated with a card network system that is obtained from the card network system.

As used herein, a third-party token or a third-party payment token refers to a payment token obtain from a third party system, such as a bank or issuer. A third-party token can comprise a temporary account for a payment authorization number. The temporary account can be associated with a temporary payment authorization number for the current payment transaction. A third-party tokenizer can send a request to a card network system associated with the payment authorization number and initiate a fund transfer for the payment amount of the payment transaction from a payment credential corresponding to the payment authorization number. After crediting the temporary account with funds from the user's payment credential, or after receiving a response from the card network system that the fund transfer was initiated successfully, the third-party tokenizer can then use the temporary account for the current payment transaction. Specifically, the third-party tokenizer uses the temporary payment authorization number for tokenizing in connection with the payment transaction. For example, the third-party tokenizer can generate a third-party payment token for the temporary payment authorization number by mapping the temporary payment authorization number to a value associated with the third party payment token.

As used herein, a gateway payment token refers to a token obtained from a payment gateway system. Specifically, a gateway payment token includes a token corresponding to a payment authorization number stored by a payment gateway system that is obtained from the payment gateway system.

As used herein, the term “payment gateway system” refers to software and servers that transmit transaction information to acquiring banks and responses from issuing banks (such as whether a transaction is approved or declined). Thus, a payment gateway system facilitates communication between banks. Furthermore, payment gateway implement Payment card Industry Data Security Standard (PCI-DSS or PCI). Payment gateway systems help bridge communication protocols and provide security on behalf of a merchant. Payment gateway systems usually charge a per transaction fee. Some example of payment gateway systems include Braintree, Dwolla, Paypal, Authorize.net.

As used herein, the term “issuer” refers to a financial institution (e.g., a bank) that issues credit cards to consumers and services their accounts. Issuers can also be a card network system or a payment gateway system. Some example of card network systems include CHASE, BANK OF AMERICA, WELLS FARGO, U.S. BANK, and CITIBANK.

Additionally, the e-commerce payment facilitator 106 receives the payment token from the third-party tokenization system and then generates a transaction token using the received payment token. In particular, the e-commerce payment facilitator 106 wraps the payment token within a transaction token. The e-commerce payment facilitator 106 can generate the transaction token using a similar process to the process in which the third-party tokenization system generated the payment token. Alternatively, the transaction token generation process can be different than the payment token generation process. The e-commerce payment facilitator 106 can then pass the transaction token to the commerce application 104, rather than passing the payment token directly to the commerce application 104 or a server associated with the commerce application 104.

As used herein, the term “transaction token” refers to a tokenized version of information for a payment transaction. In particular, a transaction token can include a numerical value that represents a payment token. The transaction token can be a randomly generated numerical value that maps to the payment token, such that the payment token cannot be derived except by the entity that has access to the mapping between the payment token and the transaction token. In one or more embodiments, a transaction token also includes other information used in processing the payment transaction. For example, a transaction token can include participant identifiers (e.g., merchant identifier, consumer identifier), a payment amount, a time period in which the transaction token is valid, or other information associated with the payment transaction. Such additional information can be referred to as “scoping information” (e.g., security domain restrictions) for scoping the use of the payment token to a specific purpose (e.g., the payment transaction) and time. Furthermore, a transaction token can be a common token usable by any payment provider or commerce application, even in international payment transactions.

As mentioned, the user 102 can interact with the commerce application 104 (e.g., via a client device of the user 102) to engage in a payment transaction with a merchant. As used herein, the term “commerce application” refers to an application that allows a consumer user to transfer funds to a recipient via one or more payment methods. For example, a commerce application 104 can allow a consumer user to initiate a payment transaction with a merchant to purchase goods or services offered by the merchant. The commerce application 104 can also include, or be part of an application that includes, messaging capabilities to allow a consumer user to communicate with a merchant. To illustrate, a commerce application 104 can include, or be part of, a merchant website or a merchant page on a social networking website. Additionally, a commerce application 104 can be associated with a merchant system, which is a system associated with the merchant that communicates with user client devices and the e-commerce payment facilitator 106 to process payment transactions between the merchant and consumers. Furthermore, the commerce application can comprise a website or application of the merchant or a website or application for the merchant provided by the e-commerce payment facilitator 106.

The commerce application 104 can auto-fill at least some of the payment information into checkout payment fields for the user 102. For example, in response to receiving the transaction token from the e-commerce payment facilitator 106, the commerce application 104 can extract information from the transaction token to auto-fill one or more fields within a payment interface associated with the purchase process. Alternatively, rather than extracting the information from the transaction token, the commerce application 104 can receive the auto-fill information from the e-commerce payment facilitator 106 with the transaction token (i.e., within a communication containing the transaction token instead of within the transaction token). To illustrate, the e-commerce payment facilitator 106 can send a payment authorization number label (e.g., “X's” for all of the digits of a payment account except the last four digits) to display to the user 102. By preventing the commerce application 104 from receiving the payment token or the full payment authorization number of the user 102, the e-commerce payment facilitator 106 can increase security and reduce fraud by allowing the user 102 to purchase items from any number of merchants using one or more payment accounts without ever having to provide the payment authorization number, or even the payment token, to the commerce application 104.

Upon reviewing the payment information within the commerce application 104, the user 102 can authorize the purchase of the order. The commerce application 104 or a server associated with the commerce application 104 (i.e., a merchant server) can forward the authorization along with the transaction token to the e-commerce payment facilitator 106. Upon receiving the authorization and the transaction token, the e-commerce payment facilitator 106 can extract the payment token from the transaction token and pass the payment token to the third-party tokenization system to obtain the payment authorization number for processing the payment transaction with the payment network 116.

In one or more embodiments, the payment network 116 includes more or fewer components as may serve a particular embodiment. Specifically, various embodiments of the payment network 116 also include one or more components for processing payment transactions between users and merchants. For instance, the payment network 116 can include components for communicating with the e-commerce payment facilitator 106 and the third-party system 118 as well as payment processing components such as bank systems associated with the users and merchants and components for communicating with the bank systems.

In one or more embodiments, the e-commerce payment facilitator 106 initiates the payment transaction with the payment network 116 differently based on the type of payment token associated with the payment transaction. Specifically, if the payment token is a gateway payment token, the payment gateway system 108 can use the gateway payment token to determine the payment authorization number and process the payment transaction via the payment processing system 110. If the payment token is a network payment token, the payment gateway system 108 can pass the network payment token to the card network system 112 via the payment processing system 110, and the network payment token can determine the payment authorization number to process the payment transaction. Alternatively, if the payment token is a third-party/one-time use payment token, the e-commerce payment facilitator 106 can communicate with the third-party system 118 to obtain the payment authorization number (e.g., associated with a temporary account), which the e-commerce payment facilitator 106 then passes to the payment network 116 to process the payment transaction.

Once the transaction is received by the payment gateway system 108 from the e-commerce payment facilitator 106, the payment gateway system 108 passes the transaction to the processor (e.g., payment processing system 110) used by the merchant's acquiring bank. Based upon the type of the payment card, the payment processing system 110 can transmit the transaction to an appropriate card network system 112. The card network system 112 can then pass the transaction to an issuing bank system 114 that issued the payment card to the user 102. If the payment token is a third-party payment token, the card network system 112 can also communicate with the third-party system 118 to obtain the payment authorization number associated with the third-party payment token for processing with the issuing bank system 114.

The issuing bank system 114 either approves or declines the transaction, and sends the decision back to the card network system 112. The decision is then transmitted from the card network system 112 back to the acquiring bank's preferred payment processing system 110. The payment processing system 110 can then forward the decision back to the payment gateway system 108. The payment gateway system 108, in one or more embodiments, stores the details concerning the transaction and the decision, and then passes the decision back to the e-commerce payment facilitator 106.

The payment gateway system 108 can also perform settlement tasks, including submitting a daily settlement batch of captured transactions to the acquiring bank via the acquiring bank's preferred payment processing system 110. The payment processing system 110 then passes the settlement batch to a server of the acquiring bank (not illustrated), which deposits the funds from the user 102/commerce application 104 transaction into the merchant's account. Then, the acquiring bank sends a request for funds in satisfaction of this order to the payment processing system 110, which passes the funding request to the appropriate card network system 112, which in turn passes the funding request to the issuing bank system 114. Then, the issuing bank system 114 posts the transaction to the account of the user 102 and passes a release of the funds to the card network system 112, which are then passed to the payment processing system 110 and then the acquiring bank.

While FIG. 1 illustrates the user 102 performing a payment transaction using the commerce application 104, the e-commerce payment facilitator 106 can allow the user 102 to make purchases at virtually any commerce application using their stored payment information without having to provide their full payment card (credit card, debit card etc.) information to any of the commerce applications. In particular, the e-commerce payment facilitator 106 can provide a transaction token containing a payment token corresponding to a payment authorization number of the user 102 to any commerce application that has integrated, or has an established communication relationship, with the e-commerce payment facilitator 106. Similarly, the e-commerce payment facilitator 106 can provide any type of payment token from any third-party tokenization system within a transaction to the commerce application 104. Thus, the e-commerce payment facilitator 106 can increase ease of making purchases using commerce applications 104, while also increasing security.

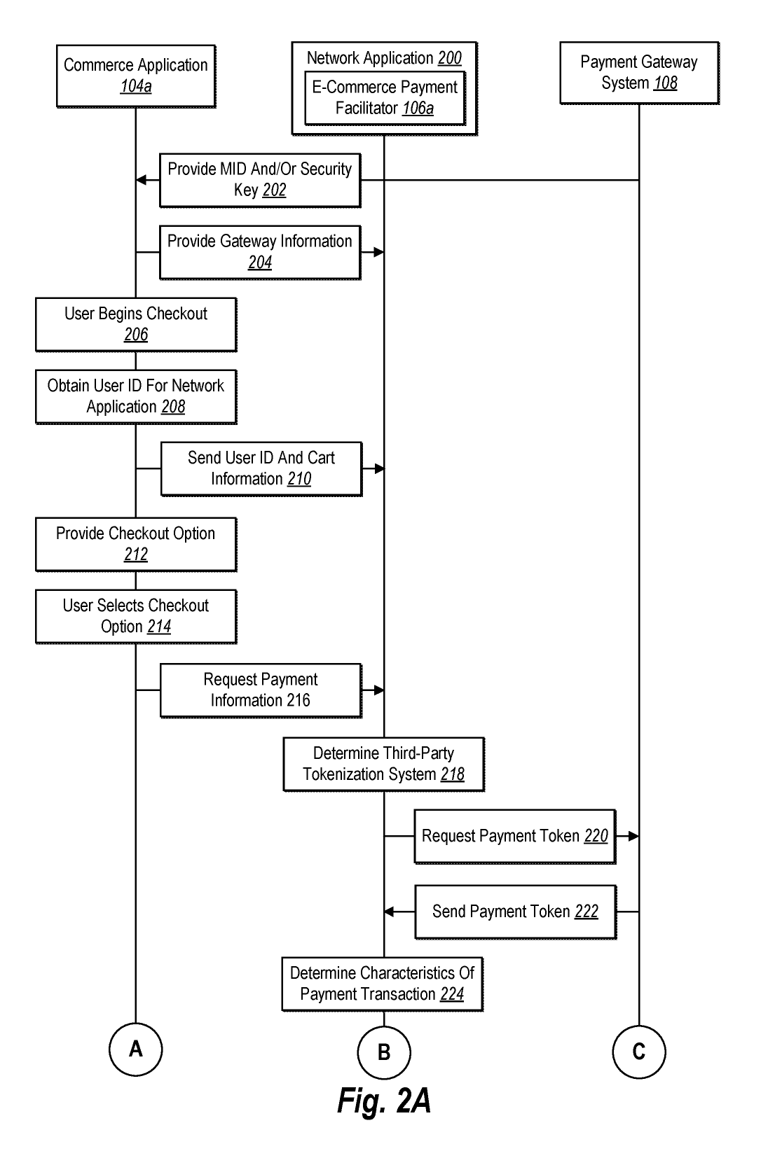

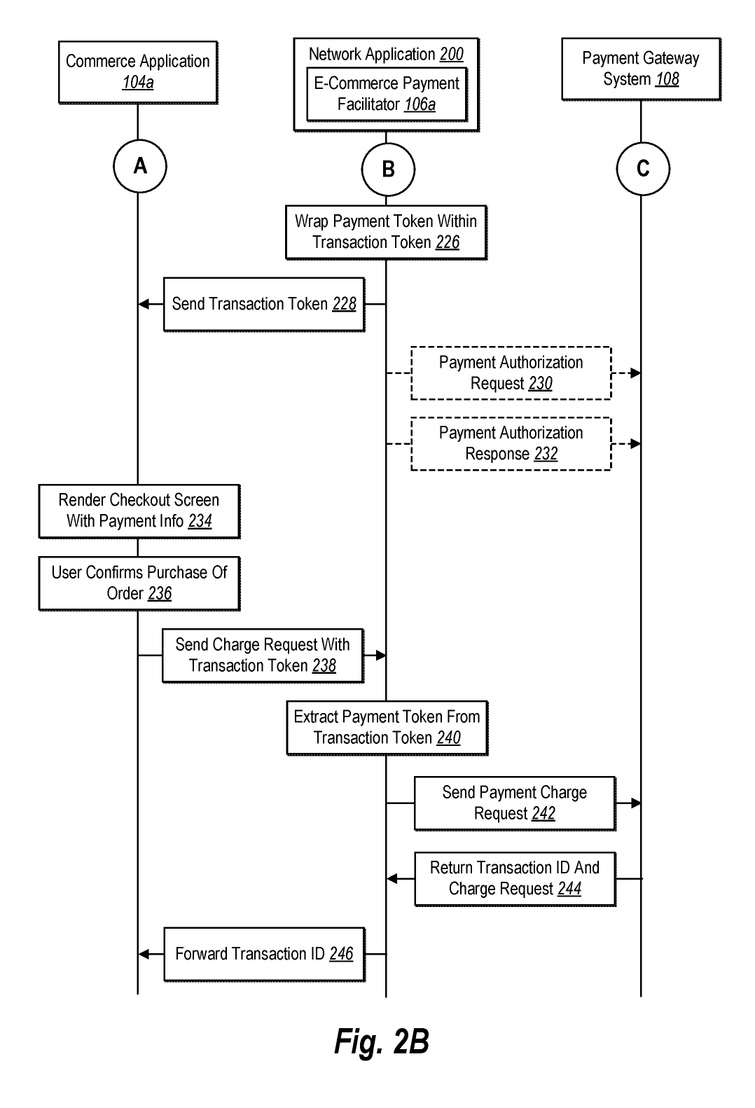

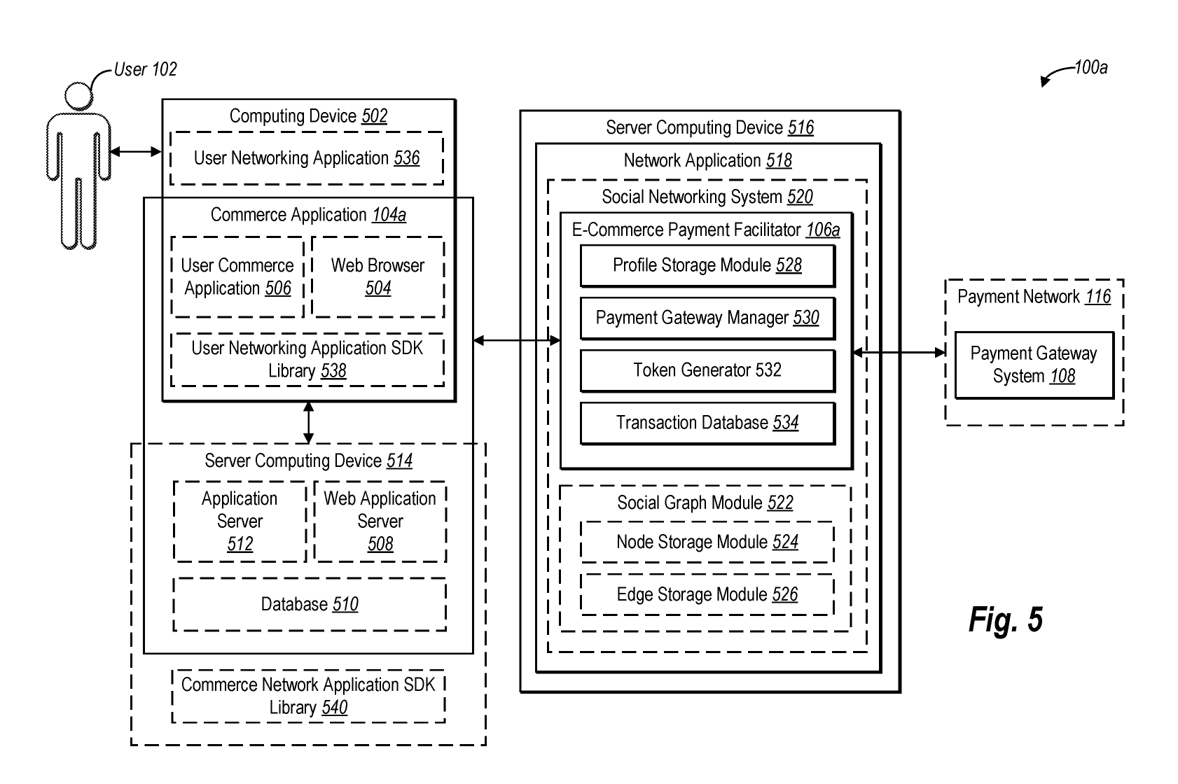

Referring now to FIGS. 2A and 2B, a sequence-flow diagram illustrating an embodiment of an e-commerce payment facilitator 106a acting as an intermediary between a commerce application 104a and/or merchant system (e.g., merchant server computing device 514 of FIG. 5) and a payment gateway system 108. For ease in explanation of FIGS. 2A-2B, reference is made to commerce application 104a. However, any of the actions associated with the commerce application 104a can optionally be performed by a server (e.g., a merchant system) associated with the commerce application 104a. The diagram of FIGS. 2A-2B illustrates one embodiment of a timeline illustrating the interactions of the commerce application 104a, the e-commerce payment facilitator 106a, and the payment gateway system 108 in accordance with a payment transaction involving a gateway payment token.

As shown, the commerce application 104a or merchant can set up an account with a payment gateway system 108. In alternative embodiments, the account/relationship between the commerce application 104a and the payment gateway system 108 can be preexisting. At some point the payment gateway system 108 can provide the commerce application 104a with a merchant identifier (MID) and/or a public key and private key 202. For example, when a merchant registers the commerce application 104a with the payment gateway system 108, the payment gateway system 108 can provide the commerce application 104a and/or the merchant with the MID and/or the public key/private key. The MID and/or the public key/private key can allow the commerce application 104a to interact with the payment gateway system 108 to process transactions and have funds deposited in an account associated with a merchant or the commerce application 104a. The MID and/or a public key/private key can allow the payment gateway system 108 to verify the identity of the commerce application 104a and any associated processing parameters (i.e., the account associated with the commerce application 104a, the payment processing system 110, the card network system 112, and bank system).

The commerce application 104a or merchant then integrates with the e-commerce payment facilitator 106 by providing the e-commerce payment facilitator 106a with gateway information 204 for the selected payment gateway system. The gateway information can include an indication of the selected payment gateway system 108 to be utilized for charging requests issued by the commerce application 104a and account information (e.g., an account identifier) that indicates a financial account (e.g., associated with a corresponding merchant) into which charged monetary amounts are to be deposited. The commerce application 104a can provide the selected payment gateway information during the first interaction with the e-commerce payment facilitator 106a. Alternatively, a merchant operating the commerce application 104a can provide the gateway information manually. For example, the merchant may provide this information to the e-commerce payment facilitator 106a using a website or a native application of the e-commerce payment facilitator 106a. In one or more embodiments, the e-commerce payment facilitator 106a (or a social networking application 200 that includes the e-commerce payment facilitator 106a) provides an application program interface (“API”) by which the commerce application 104a integrates with, and provides information to, the e-commerce payment facilitator 106a.

Additionally, the gateway information can include an indication of the MID and the public/private keys, which can allow the e-commerce payment facilitator 106a to contact the selected payment gateway system 108 on behalf of the commerce application 104a to process financial transactions. In one or more embodiments, the commerce application 104a configures the preferred payment gateway system 108 to allow the e-commerce payment facilitator 106a to issue charge requests on behalf of the commerce application 104a such that the monetary amount will be credited to an account of the merchant operating that commerce application 104a directly from the payment gateway system 108 and not from an account of the e-commerce payment facilitator 106a. Alternatively, a merchant operating the commerce application 104a can manually configure the payment gateway system, for instance, using a website of the payment gateway system 108 or a native application for the payment gateway system 108.

In addition to the foregoing, the e-commerce payment facilitator 106a can provide the commerce application 104a an app access token or pre-agreed secret code. The app access token or pre-agreed secret code can allow the commerce application 104a to prove its identity and authenticity to the e-commerce payment facilitator 106a when making API calls. In one or more embodiments, the e-commerce payment facilitator 106a provides the app access token or pre-agreed secret via a server-to-server call.

As shown, the user can begin a checkout process 206 using the commerce application 104a. In particular, the user can place one or more items or services offered by the commerce application 104a into a virtual shopping cart. In one or more embodiments, the user indicates to the commerce application 104a that they would like to checkout (e.g., selecting a checkout button or other option).

At this point, or before, the commerce application 104a can obtain, identify, or otherwise discover a user identifier 208 for the user for the network application 200. For example, the commerce application 104a can access an obfuscated (e.g., hashed, encrypted, or otherwise algorithmically transformed) user identifier of the user existing on the computing device of the user. This user identifier can identify a user profile/account for that user of a network application 200 (e.g., a social networking application). In one or more embodiments, the user identifier is accessed from a portion of shared memory accessed by or reserved by the social networking system, and may only exist if the user is currently “logged on” to the network application 200. In one or more other embodiments, the user identifier is accessed from a cookie (e.g., HyperText Transfer Protocol (HTTP) cookie) or from application cache (e.g., a HyperText Markup Language version 5 (HTML5) application cache) on the user's computing device.

This process may serve as the authentication for the user, as the existence of a proper obfuscated user identifier for the network application 200 on the user's computing device indicates that the user has already been authenticated by the network application 200, and thus the commerce application 104a may rely upon this previous authentication. Additionally, at this point of the checkout process, there is no security or privacy leak of the user's details to the commerce application 104a, which only has the obfuscated user identifier.

Upon the user beginning the checkout process 206, the commerce application 104a can optionally send to the e-commerce payment facilitator 106a the user ID and the cart information 210. In one or more embodiments the commerce application 104a can send user ID and the cart information 210 prior to rendering a checkout screen. In addition to sending the user ID and the cart information 210, the commerce application 104a can also send the app access token or pre-agreed secret code that lets the network application 200 confirm the identity of the commerce application 104a. In one or more embodiments, the cart information can include a total price of the items/services (i.e., a payment amount) in the virtual cart of the commerce application 104a.

The commerce application 104a can provide a checkout option 212 including a glyph (i.e., a mark, an icon, a graphic, a portion of text, etc.) indicating that the user may utilize the network application 200/e-commerce payment facilitator 106a to complete the purchase of the items in the virtual cart of the commerce application 104a. The checkout option can include a button presented in the checkout user interface of the commerce application 104a, a selectable overlay that appears over the checkout user interface of the commerce application 104a, a plug-in, a pop-up, or other selectable option. For example, the commerce application 104a can use iframes, SDK functions, plug-ins, functionality incorporated directly into the commerce application 104a, or any type of functionality for allowing a user to complete a purchase process.

In one or more embodiments, the user selects a checkout option 214 using the commerce application 104a to begin a checkout process. For example, XFBML or HTML5 may be used to implement, render, or call the checkout option (and/or payment information). XFBML and HTML5 may cause the page to make a call to a Javascript SDK. In at least some embodiments, the Javascript SDK enables a web page to access some or all of the payment information and/or the checkout option. Still further the commerce application 104a can use the Javascript SDK to listen to events so that the commerce application 104a knows in real time when someone clicks or otherwise selects the checkout option.

Upon the user selecting the checkout option, a request can be sent to the network application 200 for payment information 216. Or in other words, an indication can be sent to the e-commerce payment facilitator 106a that the user has selected to complete the purchase via the network application 200. For example, in one or more embodiments (such as when the commerce application 104a comprises a native application) the commerce application 104a can make a call to a graph API of the network application 200 seeking the payment information for the user 102. The graph API call seeking payment information can originate from the user's client device running the commerce application 104a and can include the previously obtained user identifier. Alternatively, the graph API call seeking payment information can originate from a server computing device running the commerce application 104a. Additionally, the graph API call can optionally include the app access token or pre-agreed secret code. In one or more embodiments, the commerce application 104a can include detailed information about items in the cart.

In alternative embodiments, (such as when the commerce application 104a comprises a web application) a web browser can execute a widget that causes the web browser to send a request to the e-commerce payment facilitator 106a seeking payment information. The web browser can identify one or more parameters from the widget and send the one or more parameters to the e-commerce payment facilitator 106a with a facilitator engagement request. The one or more parameters can include the identification of the commerce application 104a (i.e., the app access token or pre-agreed secret code), an amount of the items/services in the virtual cart, a cookie to authenticate the user as described herein.

In response to the request for the payment information 216, the e-commerce payment facilitator 106a can determine a third-party tokenization system 218 for the payment transaction. Specifically, the e-commerce payment facilitator 106a can select a third-party tokenization system from a plurality of third-party tokenization systems available for tokenizing a user's payment authorization number. For example, the e-commerce payment facilitator 106a can select a third-party tokenization based on a payment account or payment provider selected by the user. To illustrate, the payment account may be associated with a specific payment process that uses a specific type of payment token such as a gateway payment token, as described with respect to FIGS. 2A-2B, a network payment token, or a third-party payment token. Accordingly, the e-commerce payment facilitator 106a can determine the payment account and then determine that the third-party tokenization system is the payment gateway system 108 based on the type of payment token for processing payments involving the payment account being a gateway payment token.

After determining the third-party tokenization system, the e-commerce payment facilitator 106a requests a payment token 220 from the third-party tokenization system. As illustrated in FIG. 2A, the e-commerce payment facilitator 106a requests the payment token from the payment gateway system 108. For example, the e-commerce payment facilitator 106a can request a gateway payment token by sending information associated with the requesting user that allows the payment gateway system 108 to verify the identity of the user. In one or more embodiments, the e-commerce payment facilitator 106a provides a payment authorization number for the payment account of the user the first time the user requests to perform a payment transaction with the payment account. Alternatively, the e-commerce payment facilitator 106a can provide a user identifier that allows the payment gateway system 108 to correctly identify one or more payment accounts associated with the user.

In response to the request for the payment token, the payment gateway system 108 generates or otherwise obtains the payment token for the payment authorization number of the payment account for the user. Specifically, the payment gateway system 108 generates a payment token by hashing, or otherwise obfuscating, the payment authorization number. For instance, the payment token can include a 16-digit number to have a similar appearance as a credit/debit card number that maps to the payment authorization number at the payment gateway system 108. The payment gateway system 108 then sends the payment token 222 to the e-commerce payment facilitator 106a. Additionally, the payment gateway system 108 may send a cryptogram or other authentication identifier that allows the e-commerce payment facilitator 106a to authenticate the payment token with the payment gateway system 108 when returning the payment token for processing the payment transaction.

After receiving the payment token, or at any time prior to providing a transaction token as described below, the e-commerce payment facilitator 106a determines characteristics of the payment transaction 224. In particular, the e-commerce payment facilitator 106a can determine characteristics of the payment transaction that will allow the e-commerce payment facilitator 106a to assist the user in performing the payment transaction. For example, the characteristics can include details about the payment transaction required to process the payment transaction such as the payment amount, the sender, the recipient, etc. Additionally, the characteristics can include a time characteristic (e.g., a timestamp of the payment request) for tracking the progress of the payment transaction. Determining the characteristics allows the e-commerce payment facilitator 106a to scope the payment token for a specific use or payment transaction.

The e-commerce payment facilitator 106a wraps the payment token within a transaction token 226 for use with the payment transaction. Specifically, the e-commerce payment facilitator 106a generates a transaction token that includes information about the payment transaction such as one or more of the previously determined characteristics of the payment transaction (i.e., scoping information). For example, the transaction token can have an associated amount, merchant, time frame, cart, or other requirement associated with the transaction token. The e-commerce payment facilitator 106a can generate the transaction token by generating a random number associated with the information (e.g., payment token and scoping information), hashing the information, or otherwise obfuscating the information to generate a 16-digit number that resembles a debit/credit card number. Alternatively, the e-commerce payment facilitator 106a can use other methods for generating a transaction token for the payment token and the scoping information associated with the payment transaction.

The e-commerce payment facilitator 106a can map the payment token to the transaction token. For example, the e-commerce payment facilitator 106a can map the payment token to the transaction token within a database and/or with a user account for the user. Accordingly, the e-commerce payment facilitator 106a can identify the payment token based on the transaction token by accessing the database and/or the user account and looking up the payment token using the transaction token. In one or more embodiments, the e-commerce payment facilitator 106a uses encryption keys when mapping the payment token to the transaction token to obfuscate and un-obfuscate the payment token. The e-commerce payment facilitator 106a can also map scoping information contained within the transaction token to the transaction token, thereby allowing the e-commerce payment facilitator 106a to obfuscate the scoping information with the payment token.

Once the e-commerce payment facilitator 106a has generated the transaction token and mapped the transaction token to the payment token, the e-commerce payment facilitator 106a sends the transaction token 228 to the commerce application 104a. In particular, the e-commerce payment facilitator 106a sends the transaction token to the commerce application in response to the request for payment information. By sending the transaction token to the commerce application 104a instead of the payment token, the e-commerce payment facilitator 106a is able to restrict access to the payment token, thereby increasing the security of the payment transaction. Additionally, the transaction token allows the e-commerce payment facilitator 106a to provide a consistent interface (e.g., for integrating with commerce applications) regardless of the type of payment token used in the payment transaction. Furthermore, the transaction token allows the e-commerce payment facilitator 106a to scope the use of the payment token to the specific payment transaction, including to a merchant, a payment amount, and a specific time or range of times (e.g., a future time period such as one-to-two days from the request for when the merchant ships a purchased product).

The e-commerce payment facilitator 106a can also associate additional information with the transaction token. For example, the e-commerce payment facilitator 106a can tie detailed cart information to the payment token. To illustrate, the detailed cart information can include one or more products that the user has selected to purchase. This can help ensure that the payment token is only valid for the purchase of product(s) included in a digital shopping cart for the user. Additionally, this can allow the e-commerce payment facilitator 106a to know if the purchase of the cart is completed or not.

The transaction token also allows the e-commerce payment facilitator 106a to securely communicate with the commerce application 104a. Specifically, if the transaction token is somehow intercepted or maliciously obtained, the malicious entity would only be able to use the transaction token to perform the indicated payment transaction. Mapping the transaction token to the payment token at the e-commerce payment facilitator 106a ensures that only the e-commerce payment facilitator 106a is able to access the payment token mapped to the transaction token. Thus, if the malicious entity obtains the transaction token and provides the transaction token to the e-commerce payment facilitator 106a, the e-commerce payment facilitator 106a will access the mapped payment token and payment information and then attempt to initiate the payment transaction, as described below (if not already initiated). If the payment transaction has already been initiated, the e-commerce payment facilitator 106a can un-map the payment token from the transaction token, thereby rendering the transaction token invalid.

As part of indicating that the user desires to use the e-commerce payment facilitator 106a to complete the checkout process, or as an additional step, the commerce application 140a can issue an API call to the e-commerce payment facilitator 106a seeking an indication of whether the user has permitted the e-commerce payment facilitator 106a to provide the payment information of the user to the commerce application 104a. The e-commerce payment facilitator 106a can check stored permissions to determine whether the user has provided authorization to allow the commerce application 104a to access the payment information. If so, the e-commerce payment facilitator 106a can provide the transaction token to the commerce application 104a.

If the user has not provided authorization to allow the commerce application 104a to access the payment information, the process may continue by seeking permission from the user. In particular, a permissions user interface can provide the user with the option of granting the commerce application 104a access to the payment information stored by the e-commerce payment facilitator 106a. The permissions user interface may be provided by an operating system of the user's client device or through a user interface element within an instance of the network application 200 running on the user's client device. If the user grants permission, the e-commerce payment facilitator 106a can update its permissions and provide the transaction token to the commerce application 104a.

Optionally, the e-commerce payment facilitator 106a can send a payment authorization request 230 against the payment authorization number of the user for the amount of the cart to the payment gateway system 108. The payment gateway system 108 can forward the authorization request along through a payment network (e.g., payment network 116, as shown in FIG. 1), which can approve or deny payment card authorization. The payment gateway system 108 can then provide a payment authorization response 232 to the e-commerce payment facilitator 106a. One will appreciate that the optional authorization request can take place earlier or later in the timeline.

In one or more embodiments, upon receiving the transaction token from the e-commerce payment facilitator 106a, the commerce application 104a can render a checkout screen with payment info 234 contained within, or received in conjunction with, the transaction token received from the e-commerce payment facilitator 106a. For example, the commerce application 104a can auto-fill payment fields of a checkout screen with any payment information received. One will appreciate in light of the disclosure herein that the e-commerce payment facilitator 106a may not have information for each payment field of the commerce application 104a checkout screen, or may include outdated information. In such instances, the user can change the auto-filled information in one or more payment fields or add information in any blank payment fields.

In alternative embodiments (such as when the commerce application 104a comprises a web application) when executing a widget, a web browser can create a frame (e.g., an iframe). The response to the request payment information can include content for inclusion in the frame (e.g., the payment info). The web browser then renders the checkout screen (which includes the frame) using the information received in the response from the e-commerce payment facilitator 106a and displays the checkout screen and the frame, with the information from the e-commerce payment facilitator 106a displayed in the frame. By including the widget in markup language document describing a web page of the commerce application 104a, payment information from the e-commerce payment facilitator 106a can be displayed along with the web page. In such embodiments, the commerce application 104a does not auto-fill the payment fields, but rather renders the payment information when the commerce application 104a renders the frame.

Upon the commerce application 104a rendering the checkout screen with the payment information in the payment fields, the user can confirm the purchase of the order 236 or otherwise complete the transaction in as little as a single click or user input. For example, when the e-commerce payment facilitator 106a provides information for each of the required payment fields, the user can select a “pay” or “order” button or other selectable option to complete the transaction. In alternative embodiments, the user may be required to complete one or more payment fields for which data was not supplied or otherwise perform additional operations to complete the transaction.

The commerce application 104a can then send a charge request with the transaction token 238 to the e-commerce payment facilitator 106a. In particular, the commerce application 104a can make a call to a payment API of the network application 200 that includes the charge request. The charge request can include the transaction token previously provided to the commerce application 104a and a confirmation that the user has selected to complete the transaction. Alternatively or additionally, the charge request can include an order ID that identifies or maps to cart information. Still further, the charge request can include a user ID for the user and/or the app access token or pre-agreed secret code.

Optionally, the charge request can further include any of the cart information previously described. For example, one or more details of the order (including, but not limited to, an obfuscated user identifier, a transaction number previously provided by the commerce application 104a and/or the network application 200, a monetary amount to be charged to the user, an identifier of the commerce application 104a, etc.) are transmitted to the e-commerce payment facilitator 106a as part of a charge request. One will appreciate in light of the disclosure herein that when the payment information is sent with the charge request, the e-commerce payment facilitator 106a can determine if the user updated or added any information to the provided payment information. If the user added or changed any information, the e-commerce payment facilitator 106a can update the payment profile of the user in a user account and/or provide the updated information to the payment gateway system 108.

In response to receiving the charge request, the e-commerce payment facilitator 106a can extract or access the payment token using the transaction token 240. For example, as previously mentioned, the e-commerce payment facilitator 106a can perform a lookup within a database to locate a mapping for the transaction token. The e-commerce payment facilitator 106a can then identify the payment token mapped to the transaction token. Additionally, the mapping can include scoping information that allows the e-commerce payment facilitator 106a to determine whether the payment token is valid for the payment transaction requested. Alternatively, the e-commerce payment facilitator 106a can identify the payment token using an encryption key or other decryption/verification method according to the method used to create the transaction token. The e-commerce payment facilitator 106a also identifies the payment information and scoping information based on the transaction token.

At this point that e-commerce payment facilitator 106a can determine if the transaction token is valid or valid for the requested transaction by verifying that the transaction complies with the scoping information associated with the transaction token. For example, the e-commerce payment facilitator 106a can verify that the amount of the transaction meets an approved amount in the scoping information, can verify that the time meets a time requirement in the scoping information, can verify the merchant or cart meets a merchant or cart requirement, etc. If the e-commerce facilitator 106a determines that the transaction does not comply with the scoping information, the e-commerce facilitator 106a can cancel the transaction. If the e-commerce facilitator 106a determines that the transaction does comply with the scoping information, the e-commerce facilitator 106a can process the transaction.

In one or more embodiments, the after extracting the payment token (and verifying the scoping information), the e-commerce payment facilitator 106a sends a payment charge request 242 to the payment gateway system 108. The payment charge request can include the payment token extracted from the transaction token along with additional payment information for processing the payment transaction and a cryptogram (if applicable). For example, the e-commerce payment facilitator 106a can provide an expiration date of a payment card (if applicable), billing/shipping address of the user, an indication of the commerce application 104a (e.g., MID or other identifier), and/or an indication of authorization to submit charge requests on behalf of the commerce application 104a. The indication of authorization can include encoding one or more portions of the request using an encryption key or other identifier previously provided by the payment gateway system 108 (e.g., when providing the payment token to the e-commerce payment facilitator 106a).

The payment gateway system 108 can process the payment charge request using the payment network 116 as described above in relation to FIG. 1. The payment gateway system 108 can return a transaction ID and a charge response 244 to the e-commerce payment facilitator 106a. The transaction ID can allow the payment gateway system 108 to update the e-commerce payment facilitator 106a or the commerce application 104a with updates regarding the transaction (funded, denied, returns, etc.). The e-commerce payment facilitator 106a can then forward the transaction ID 246 to the commerce application 104a. The transaction ID can allow the commerce application 104a to query the payment gateway system 108 regarding the transaction as may serve a particular embodiment.

Additionally, while FIGS. 2A-2B illustrate an embodiment involving wrapping a gateway payment token within a transaction token, the e-commerce payment facilitator 106a can also generate transaction tokens for network payment tokens and third-party payment tokens. For example, in an embodiment involving a network payment token obtained from a card network system (e.g., card network system 112 of FIG. 1), the e-commerce payment facilitator 106a can communicate with the card network system via the payment gateway system 108. The e-commerce payment facilitator 106a can receive the network payment token from the payment gateway system 108 and generate a transaction token as described in relation to the gateway payment token. Similarly, the e-commerce payment facilitator 106a can extract the network payment token from the transaction token after receiving the request charge from the commerce application 104a, and then pass the network payment token back to the payment gateway system for processing the payment transaction.

In an embodiment involving a third-party payment token obtained from a third-party system (e.g., third-party system 118 of FIG. 1), the e-commerce payment facilitator 106a obtain a third-party token from the third-party system for a payment transaction. The e-commerce payment facilitator 106a generates the transaction token to wrap the third-party payment token and passes the transaction token to the commerce application 104a in response to a payment request. When the e-commerce payment facilitator 106a receives the transaction token back from the commerce application 104a, the e-commerce payment facilitator 106a extracts the third-party payment token from the transaction token and returns the third-party payment token to the third-party system via the payment gateway system 108 to process the payment transaction.

Accordingly, the e-commerce payment facilitator 106a can provide processing of a plurality of different types of payment tokens. In any of the above embodiments, the commerce application 104a receives a transaction token via the same interfacing process, thereby reducing the work required by the commerce application 104a to integrate with the e-commerce payment facilitator 106a. Additionally, the e-commerce payment facilitator 106a can provide dynamic selection of a payment method to use one of a plurality of different types of payment tokens based on the requirements for a particular payment authorization number, user, commerce application 104a, and/or payment gateway system 108. The dynamic selection can also be based on a risk level associated with a payment transaction such that higher risk payment transactions use a specific payment token type, while lower risk payment transactions may use any payment token type. The dynamic selection can also allow for routing to different providers or payment gateway systems based on costs or rates associated with the various providers or payment gateway systems, which is especially useful in international transactions.

Furthermore, while FIGS. 2A-2B illustrate a specific order of performing the payment transaction process, the e-commerce payment facilitator 106a can assist with the payment transaction process according to other sequences of processing steps. For example, instead of generating the transaction token after the user selects a checkout option and before the user confirms the purchase order, the e-commerce payment facilitator 106a can generate the transaction token at any time prior to or after the user confirms the purchase order. Thus, the e-commerce payment facilitator 106a can adapt the payment transaction process for a plurality of different commerce applications even if the commerce applications provide a different payment transaction flow to their respective customers.

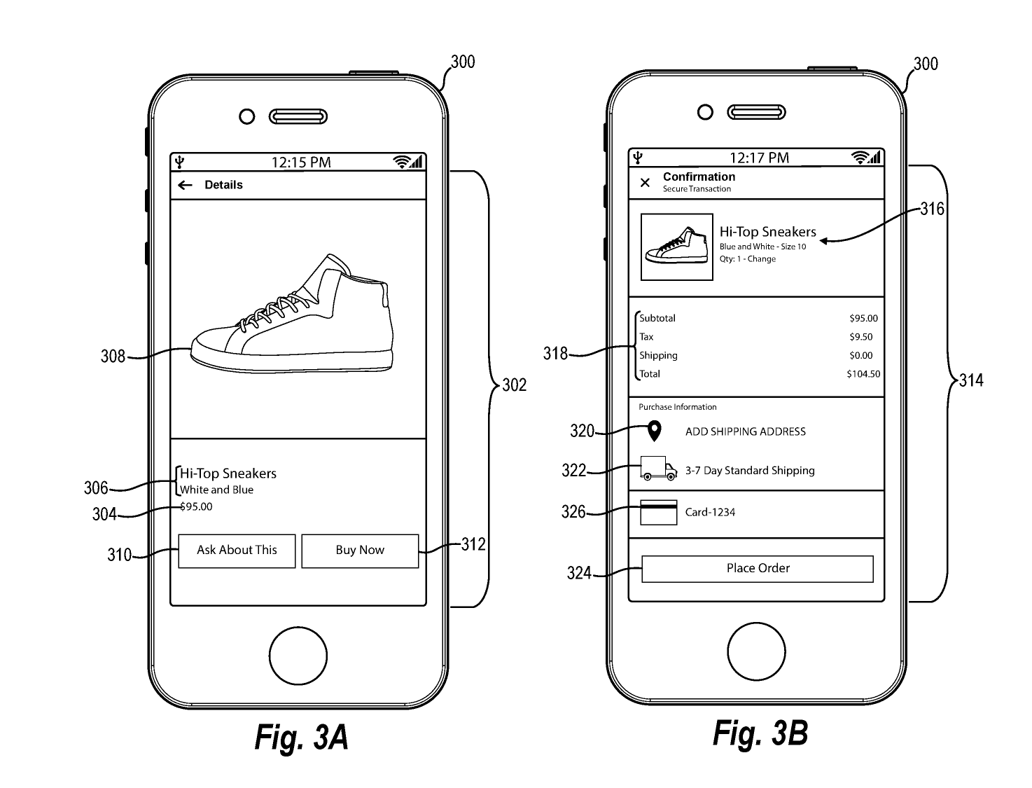

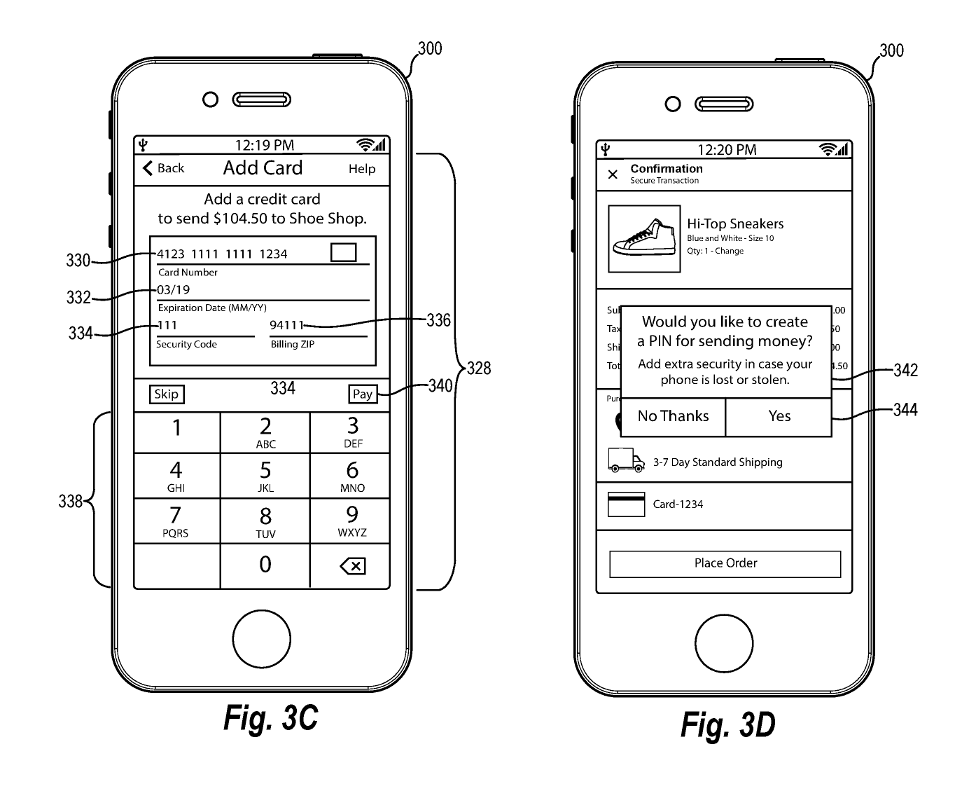

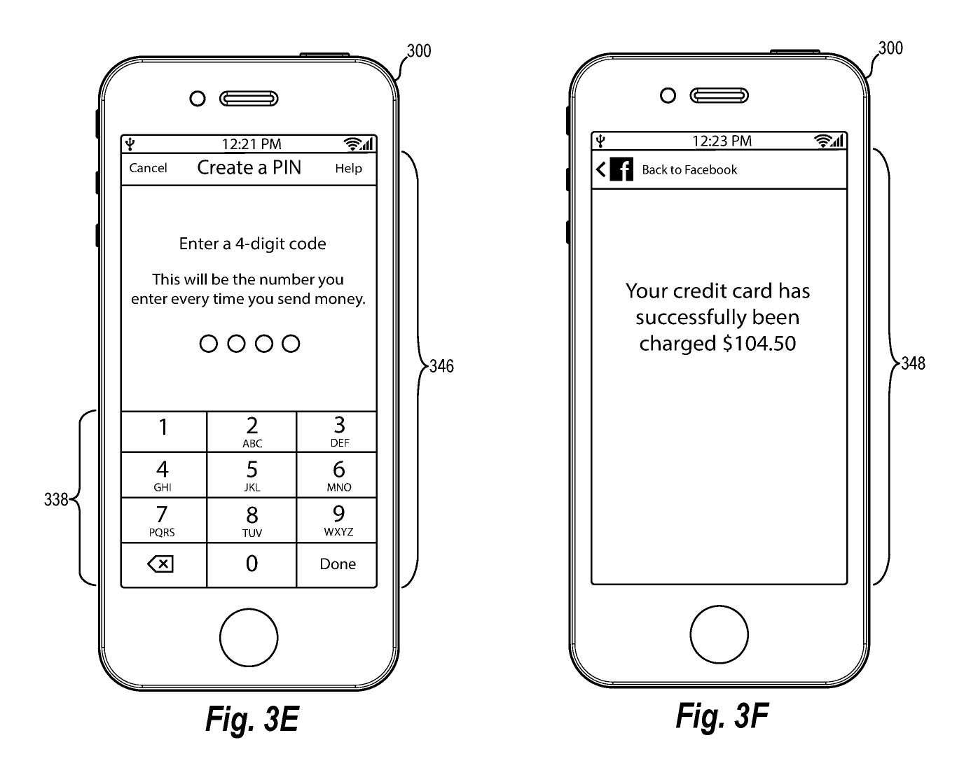

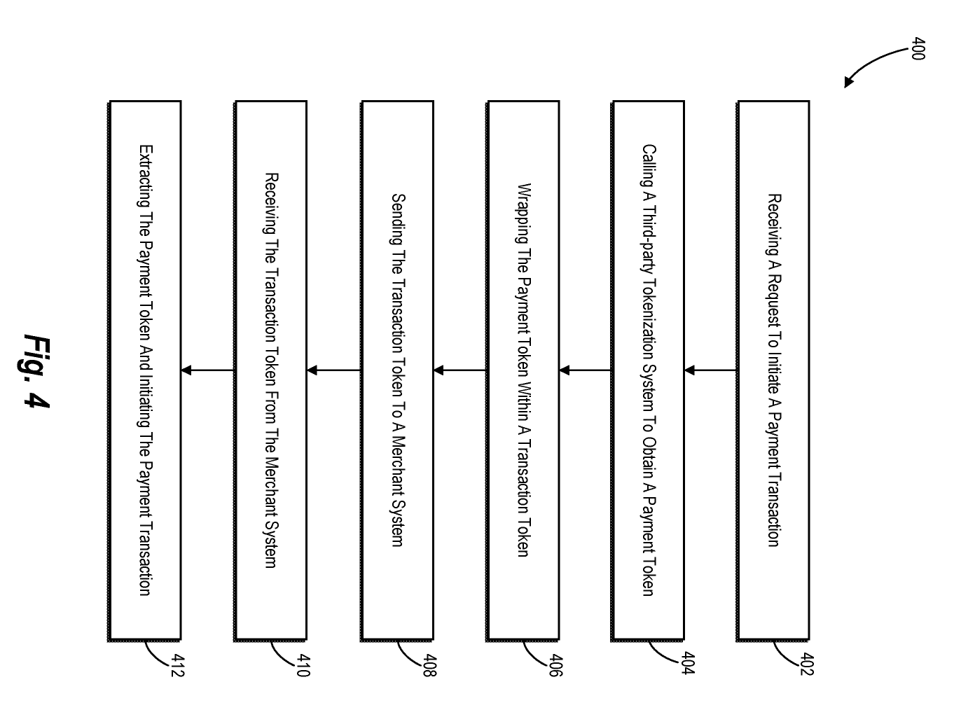

In light of the foregoing description, one will appreciate that the e-commerce payment facilitator 106a can provide a number of benefits over conventional commerce application payment processes and checkout processes. As discussed above, the e-commerce payment facilitator 106a can increase the security and integration consistency of a checkout process for a merchant by wrapping payment tokens within transaction tokens to provide to a commerce application 104a. FIGS. 3A-3F illustrate user interfaces of a checkout process within a client application that utilizes the e-commerce payment facilitator 106a. As described later, the client application running on the user's client device may or may not be part of the commerce application 104a.

For example, FIGS. 3A-3F illustrate various views of GUIs provided by a commerce application to facilitate electronic messaging and sending and receiving payments. FIGS. 3A-3F illustrate a consumer client device 300 that can allow a user (e.g., a consumer) to interact with a merchant via the client application. Specifically, the client application allows the consumer to view information associated with goods and services provided by the merchant and to enter into a payment transaction with the merchant. The client application can allow the user to view and/or purchase any number of goods or services provided by the merchant in one or more payment transactions. In one or more embodiments, the commerce application also allows the consumer to communicate with the merchant via an instance of a commerce application on a client device of the merchant.

FIGS. 3A-3F illustrate the consumer client device 300 as a handheld device. As used herein the term “handheld device” refers to a device sized and configured to be held/operated in a single hand of a user. In additional or alternative example, however, any other suitable computing device, such as, but not limited to, a tablet device, a handheld device, larger wireless devices, laptop or desktop computer, a personal-digital assistant device, and/or any other suitable computing device can perform one or more of the processes and/or operations described herein.

With reference to FIGS. 3A-3F, as mentioned, the consumer can interact with display elements in one or more user interfaces of the client application to initiate a payment transaction with a merchant to purchase a good or service. FIG. 3A illustrates a merchant page interface 302 of the client application. In one or more embodiments, the client application is a web browser that allows the consumer to access a merchant page interface 302 associated with the merchant (e.g., via a website for the merchant). Alternatively, the client application includes a standalone application associated with the merchant, such as a merchant-specific application by which consumers can view and purchase products provided by the merchant. In yet another embodiment, the client application is associated with a social networking system, such that the merchant page interface 302 is accessible via the social networking system. In any case, the merchant page interface 302 can display a product or service provided by the merchant that consumers may purchase via the social networking system.

According to one or more embodiments, the merchant page interface 302 includes a plurality of products or services available from the merchant. For example, the merchant page interface 302 may include a listing of products, each of which may be selectable and/or have its own merchant page. Selecting the merchant page for a specific item displays details about the corresponding product. For example, the merchant page for a given product (as displayed in FIG. 3A) may display the price 304, product specifications 306, an image 308 of the product, and related items available from the merchant.

In one or more embodiments, the client application also allows the consumer to communicate with the merchant about the displayed item. For example, the merchant page interface 302 can present a communication option 310 to communicate with the merchant. To illustrate, selecting the communication option 310 can cause the client application to open a messaging interface that allows the consumer to communicate (e.g., by instant messaging) with the merchant. The consumer can discuss pricing, purchase options, delivery options, availability, customization, and/or other information about the displayed product.

The merchant product interface 302 can also display a purchase option 312 for a product on the merchant page for the product. Selecting the purchase option 312 can cause the client application to add the product to a virtual shopping cart and/or display a purchase interface to purchase the product via the e-commerce payment facilitator 106a. FIG. 3B illustrates a purchase interface 314 to purchase the product illustrated in FIG. 3A. When the consumer selects the purchase option 312, the client application adds the selected product to a virtual shopping cart and displays the purchase interface 314 with the contents of the shopping cart. The consumer can select a plurality of objects to add to the shopping cart prior to purchasing the product(s).

The purchase interface 314 includes purchase information including payment transaction information. In particular, the purchase information includes product details 316, (including the quantity of the product), a purchase price 318, shipping details, and a payment method for completing the payment transaction. Although FIG. 3B illustrates a set of details associated with the shopping cart, the purchase interface 314 may include additional or alternative details that allow the user to verify and enter purchase information.

In one or more embodiments, the purchase interface 314 includes an option 320 to provide a shipping address and an option 322 to provide a shipping method. For example, the consumer can select the option 320 to provide a shipping address and enter a delivery address for the product to be delivered. Additionally, the consumer can select the option 322 to provide a shipping method (e.g., express, standard, overnight). Changing the shipping method may cause the client application to update the price of the product by increasing or decreasing shipping fees. The purchase interface 314 may also provide a default shipping method (e.g., a free shipping method such as standard shipping).

The purchase interface 314 can also include an option 324 to place the order for the product identified in the purchase interface 314. Specifically, if the consumer has previously added a payment credential, the option 324 to place the order uses the selected payment credential to process the order for the payment amount. Additionally, the consumer client device 300 sends the payment transaction information to the e-commerce payment facilitator 106a to initiate the payment transaction with the merchant.

In one or more embodiments, to display payment credential information on the purchase interface 314, the e-commerce payment facilitator 106a can communicate with a payment network to obtain a payment token for using with the payment transaction. For example, the e-commerce payment facilitator 106a can determine a specific payment method (e.g., a default payment method) for use with the current payment transaction and then send information to the payment gateway system that allows the payment gateway system to provide the correct payment token to the e-commerce payment facilitator 106a. The e-commerce payment facilitator 106a can then wrap the payment token within a transaction token with additional payment information (e.g., the scoping information previously described) to allow the client application to provide the relevant information to the consumer. The consumer can then verify the payment information (including the information corresponding to the user and/or selected payment credential) and select the option 324 to place the order.

Alternatively, if the consumer has not previously added a payment credential, or if the consumer desires to add a new payment credential, the purchase interface 314 may also include a payment method option 326 for selecting or changing a payment method for completing the purchase. In one or more embodiments, the payment method option 326 allows the consumer to provide a new card account or modify an existing card account. Selection of the payment method option 326 can cause the client application to display a payment credential interface 328, as illustrated in FIG. 3C. Specifically, the payment credential interface 328 displays a plurality of fields in which the consumer enters payment credential information to add a payment credential for processing payment transactions. For example, the payment credential interface can include a payment authorization number field 330 for a payment authorization number, an expiration field 332 for an expiration date, a security code field 334 for a security code, and a ZIP code field 336 for entering a billing ZIP code. The payment credential interface 328 can include a keyboard interface 338 to allow the consumer to enter information into the corresponding fields.

In one or more embodiments, after adding the payment credential, the consumer can select a pay option 340 to pay the payment amount identified in the purchase interface of FIG. 3C. Selecting the pay option 340 initiates the payment transaction process with the e-commerce payment facilitator 106a. For example, the e-commerce payment facilitator 106a can pass the information for the payment credential to the payment network to process the payment transaction. The e-commerce payment facilitator 106a can store abbreviated information for the payment credential (e.g., a name of the payment credential) for future use. Thus, the e-commerce payment facilitator 106a can store abbreviated information for the payment credential with a user account of the consumer to allow the consumer to more quickly and easily select the payment credential in the future without having to re-enter all of the payment information. The e-commerce payment facilitator 106a can also obtain a payment token for the added payment credential to wrap within a transaction token and then proceed with the payment transaction as described previously.

In one or more embodiments, the client application allows the user to set up a secure login or PIN to access payment functionality within the client application. For example, after the user selects the pay option 40 (or the option 324 to place the order), the client application displays a message to the consumer requesting whether the consumer would like to enter a PIN for security. FIG. 3D illustrates a message 342 requesting whether the consumer would like to enter a PIN to provide additional security for initiating payment transactions using the consumer client device 300. The message may be an overlay or a separate interface, as may serve a particular embodiment.

If the consumer selects an option 344 to enter a PIN, the client application can display a PIN interface 346 that allows the consumer to enter a PIN, as illustrated in FIG. 3E. The PIN interface 346 includes a keyboard interface 338 that allows the consumer to select a plurality of digits (e.g., a 4-digit code) as the PIN. Providing a PIN allows the consumer to add additional security measures in case the consumer client device 300 is lost or stolen. The PIN helps prevent fraudulent payment transactions from the consumer client device. Alternatively, the consumer may choose not to enter a PIN for initiating payment transactions.

As mentioned, after the consumer provides payment credentials to the e-commerce payment facilitator 106a (e.g., via the merchant), and after the e-commerce payment facilitator 106a obtains the payment token for the payment transaction from the tokenization system, the e-commerce payment facilitator 106a wraps the payment token within a transaction token. The e-commerce payment facilitator 106a sends the transaction token to the merchant, which can then return the transaction token to the e-commerce payment facilitator 106a to charge the consumer's payment credential for the payment amount in response to the user confirming the purchase (e.g., by entering the PIN or otherwise selecting an option to complete the order). For example, the merchant can return the transaction token in response to shipping the purchased product. The e-commerce payment facilitator 106a then initiates the payment transaction by extracting the payment token from the transaction token and sending the payment token to the payment gateway system.

After completing the payment transaction, the consumer client device 300 can receive a notification from the payment system 108 that the payment transaction is complete and cause the client application to display a successful payment message. The successful payment message 348, as illustrated in FIG. 3F, can indicate that the consumer's payment account was successfully charged for the payment amount. A completed payment transaction can also cause the client application to update a transaction history for the consumer, which the consumer may access to view details about previously initiated/completed/canceled payment transaction.

Turning now to FIG. 4, this figure illustrates a flowchart of a series of acts 400 of facilitating a payment transaction between a user and merchant using a transaction token in accordance with one or more embodiments. While FIG. 4 illustrates acts according to one embodiment, alternative embodiments may omit, add to, reorder, and/or modify any of the acts shown in FIG. 4. The acts of FIG. 4 can be performed as part of a method. Alternatively, a non-transitory computer readable medium can comprise instructions, that when executed by one or more processors, cause a computing device to perform the acts of FIG. 4. In still further embodiments, a system can perform the acts of FIG. 4.

The series of acts 400 includes an act 402 of receiving a request to initiate a payment transaction. For example, act 402 involves receiving a request to initiate a payment transaction between a user and a merchant. Act 402 can involve receiving a request to initiate a payment transaction involving a purchase of a product by the user from the merchant. Act 402 can involve receiving a request to purchase the product via a commerce application associated with the merchant. The commerce application can include a web browser accessing a merchant website or a standalone merchant application. Alternatively, the commerce application can include a network application associated with a social networking system, the commerce application including a merchant page for the merchant.

The series of acts 400 also includes an act 404 of calling a third-party tokenization system to obtain a payment token. For example, act 404 involves calling a third-party tokenization system to obtain a payment token representing a payment authorization number corresponding to the payment transaction. Act 404 can involve determining a plurality of third-party tokenization systems associated with the merchant. Act 404 can then involve selecting the third-party tokenization system from the plurality of third-party tokenization systems from which to obtain the payment token based on a transaction cost associated with the payment transaction. For instance, the third-party tokenization system can include a payment gateway system within the payment network. Accordingly, the payment token can include a gateway payment token. Alternatively, the payment token can include a network payment token or a third-party payment token. A third-party token can include a one-time use payment token associated with a temporary account at a third-party system.

Additionally, the series of acts 400 includes an act 406 of wrapping the payment token within a transaction token. For example, act 406 involves wrapping the payment token representing the payment authorization number within a transaction token. For instance, act 406 can involve generating a numerical value by obfuscating the payment token. The numerical value can include a randomized value mapped to the payment token. Alternatively, the numerical value can include a hashed value of the payment token. The transaction token can also include scoping information that scopes the payment token to be used only with the payment transaction.

Act 406 can also involve establishing a mapping between the transaction token and the payment token. For example, establishing the mapping can include storing the mapping within a database comprising transaction tokens. Act 406 can also include establishing a mapping between the transaction token and payment transaction information for the payment transaction. For example, establishing the mapping can include tying the transaction token to a user account of the user with a transaction identifier. Additionally, the payment transaction information can include scoping information associated with the payment token, including a merchant identifier, a payment amount, and a time period in which the payment token is valid.

Act 406 can also involve wrapping a payment amount of the payment transaction and a merchant identifier for the merchant within the transaction. Act 406 can further involve wrapping, within the transaction token, a time period in which the transaction token is valid for the payment transaction. The time period in which the transaction token is valid can be a future time period. For example, the time period can be associated with a typical transaction time corresponding to shipping a product purchased by the user.

The series of acts 400 further includes an act 408 of sending the transaction token to a merchant system. For example, act 408 involves sending the transaction token to a merchant system associated with the merchant in connection with the payment transaction. Act 408 can involve sending the transaction token to the merchant system with a transaction identifier associated with the payment transaction. Act 408 can also involve providing the merchant system with cart information about one or more products within a virtual shopping cart associated with the payment transaction.

The series of acts 400 also includes an act 410 of receiving the transaction token from the merchant system. For example, act 410 involves receiving, from the merchant system, the transaction token in connection with a request to process the payment transaction. Act 410 can involve receiving the transaction token in response to the merchant system performing one or more actions associated with processing a purchase order by the user. For example, act 410 can involve receiving the transaction token in response to the merchant system shipping a product to the user. Act 410 can involve receiving the transaction token within a time period designated within the transaction token.

The series of acts 400 includes an act 412 of extracting the payment token and initiating the payment transaction. For example, act 412 involves, based on receiving the transaction token, extracting the payment token, and initiating the payment transaction by sending the payment token to a payment network associated with the merchant. Act 412 can involve extracting the payment token by performing a lookup within a database to determine a mapping between the transaction token and the payment token to identify the payment token.

Additionally, act 412 can involve extracting scoping information from the transaction token to determine whether the payment token is valid. For example, act 412 can involve extracting a payment amount and a merchant identifier from the transaction token. Act 412 can further involve extracting a time period in which the transaction token is valid for the payment transaction. Act 412 can involve sending the payment amount and the merchant identifier to the payment network associated with the merchant.

The series of acts 400 can also include tracking a status of the transaction token for the payment transaction token. The series of acts 400 can also include an act of using the status of the transaction token to determine a fraud level associated with the user or the merchant. The series of acts 400 can also include authorizing or rejecting the payment transaction based on the fraud level associated with the user or the merchant.

FIG. 5 illustrates a schematic diagram illustrating a system 100a in accordance with an embodiment. System 100a illustrates one example embodiment of the system 100 of FIG. 1. In particular, FIG. 5 illustrates one embodiment of a commerce application 104a and an e-commerce payment facilitator 106a. As shown by FIG. 5, the user 102 can use a computing device 502 to access a commerce application 104a. In embodiments where the commerce application 104a is a web application, the user 102 may interface with the commerce application 104a using a web browser 504 application or a user commerce application 506 (also referred to as a special-purpose client application later herein), and thus these applications may or may not be considered as part of the commerce application 104a.

In such embodiments where the commerce application 104a is a web application, the backend of the commerce application 104a (i.e., the set of applications providing data and logic for the commerce application 104a) may include a web application server 508 (including but not limited to the Apache HTTP Server by the Apache Software Foundation, Internet Information Services (IIS) by Microsoft Corporation, nginx by NGINX, Inc., the open-source lighttpd web server, and Google Web Server (GWS) by Google Inc.) and optionally a relational or non-relational database 510 (including but not limited to MySQL by Oracle Corporation, PostgreSQL by the PostgreSQL Global Development Group, Apache Cassandra by the Apache Software Foundation, HBase by the Apache Software Foundation, and MongoDB by 10gen).

In embodiments where the commerce application 104a is a native application, the user 102 utilizes the user commerce application 506), which may utilize an application server 512 (e.g., a Java application server) and/or database 510 of a separate server computing device 514 and thus be deemed a network application, or may not utilize the application server 512 or database 510 and thus be deemed a “standalone” application. Accordingly, depending upon the context of the term “commerce application,” this term may refer to software executing on the user's computing device 502 and/or the server computing device 514. In particular, at least a first portion of the commerce application software can execute on the user's computing device 502 and at least a second portion of the commerce application software can execute on the set of one or more server computing devices 514.

The commerce application 104a can interact with an e-commerce payment facilitator 106a to initiate and/or process payment transactions for users, such as user 102. Additionally, the e-commerce payment facilitator 106a can interact with a payment gateway system 108 of a payment network 116 to process transactions, as described above in relation to FIG. 1. The depicted embodiments illustrate a single payment gateway system 108 and a single payment network 116. One will appreciate that the e-commerce payment facilitator 106a can interface with any number of different payment gateway systems and payment networks to process payments and financial transactions. For example, the e-commerce payment facilitator 106a can interface with a first payment gateway system 108 for a first commerce application (e.g., commerce application 104a), and interface with a second payment gateway system for a second commerce application.

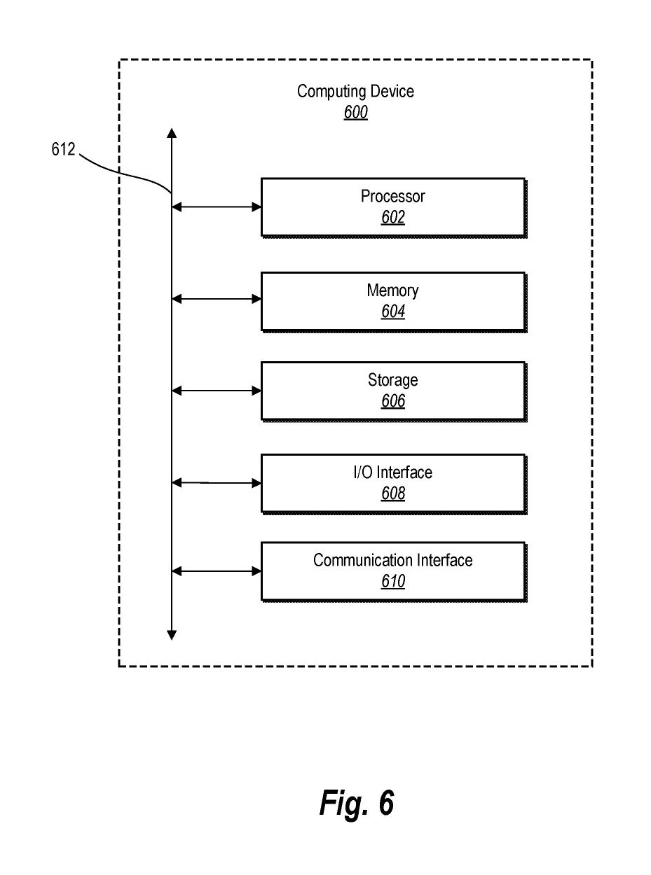

The system 100a of the embodiment illustrated in FIG. 5 includes a set of one or more server computing devices 516 that provide a network application 200 including an e-commerce payment facilitator 106a. In one or more embodiments, the network application 200 comprises a social networking system 520 (such as, but not limited to, FACEBOOK™). In other embodiments, the network application 200 includes another type of application including, but not limited to, an e-mail application, search engine application, banking application, or any number of other application types that utilize user accounts. In one or more embodiments where the network application 200 comprises a social networking system 520, the network application 200 may include a social graph module 522 for representing and analyzing a plurality of users and concepts. A node storage module 524 of the social graph module 522 can store node information comprising nodes for users, nodes for concepts, and nodes for items. An edge storage module 526 of the social graph module 522 can store edge information comprising relationships between nodes and/or actions occurring within the social networking system 520. Further detail regarding social networking systems, social graphs, edges, and nodes is presented below with respect to FIG. 6. The network application 200 can create a node for a payment token and a transaction token, or nodes for each, and generate edges that connect the nodes for the payment token and the transaction token to node for a user, as described below.

The e-commerce payment facilitator 106a of the network application 200 can comprise a profile storage module 528 that provides storage for payment information of users of the network application 200. For example, the user 102 can create an “account” with the network application 200, which allows a user to provide user information, including payment credentials or other payment information, to the network application 200. The network application 200 can then save at least some of the user information and/or payment information in the profile storage module 528. In one or more embodiments the profile storage module 528 can store in relation to the user 102 one or more of: a first name, a middle name, a last name, a name of a payment credential, abbreviated/obfuscated payment credential information such as the last four digits of a payment authorization number, a billing address (including street name, house number, city, state or province, zip code, country, etc.) associated with the payment credential, a phone number associated with the payment credential, or one or more shipping addresses (including similar fields as the billing address). When the payment credential comprises a debit card, the profile storage module can also store a personal identification number (PIN) for the debit card. In an embodiment where the network application 200 comprises a social networking system 520, the payment information stored in the profile storage module 528 may be associated with a node of the node storage module 524 that represents the user 102.

The profile storage module 528 can also store mappings between payment tokens and transaction tokens for payment transactions and/or users. For instance, when the token generator 532 generates a transaction token, as described below, the profile storage module 528 stores a mapping between the transaction token and the corresponding payment token so that the e-commerce payment facilitator 106a can determine the payment token in response to receiving the transaction token. The profile storage module 528 can also map payment information associated with the payment transaction to the transaction token, including scoping information that indicates one or more scoping characteristics of the payment token. Accordingly, the profile storage module 528 can store scoping information such as a merchant identifier, a payment amount for a payment transaction, and a time period in which the payment token is valid.

In the depicted embodiment, the e-commerce payment facilitator 106a also includes a payment gateway manager 530. Upon receiving a charge request from a commerce application 104a, the payment gateway manager 530 can determine which payment gateway system 108 of a plurality of payment gateway systems is to be used to process the charge request. In an embodiment, the payment gateway manager 530 utilizes the charge request and information stored in the profile storage module 528 to make this determination.

For example, in an embodiment, the profile storage module 528 is further configured to receive and/or store, for one or both of the commerce application 104a and the merchant operating the commerce application 104a, a payment gateway identifier that indicates which payment gateway system is to be used to process charge requests for the commerce application or merchant. Additionally, the profile storage module 528 may also include an application identifier (or merchant identifier, or account identifier) to be used when interacting with the identified payment gateway system to identify which account is to be credited with the funds from the user 102. In at least some embodiments, the payment gateway manager 530 identifies the payment gateway system 108 based either in part or exclusively upon information from within the received charge request itself.

The payment gateway manager 530 can further request payment tokens from the payment network 116 in connection with payment transactions. Specifically, the payment gateway manager 530 can request payment tokens representing payment authorization numbers associated with selected payment credentials for processing payment transactions. The payment network 116 can provide the payment tokens in response to the requests to allow the e-commerce payment facilitator 106a to generate transaction tokens in connection with initiating/processing the payment transactions.

As described in more detail above, the e-commerce payment facilitator 106a can also include a token generator 532 for generating transaction tokens. The token generator 532 can generate transaction tokens that the e-commerce payment facilitator 106a can send to the commerce application 104a rather than sending payment tokens obtained from the payment network 116. The token generator 532 can return a random string as a pointer to the payment token received from the payment network 116. The transaction token may have no algorithmic relationship with the original payment token, so that the payment card number cannot be derived based on the token itself (such as by merely applying a decryption algorithm to the token). Accordingly, this token is not considered cardholder data, because it is a random string from which it is not possible to extrapolate any original cardholder data without the use of the token generator 532 and profile storage module 528, which contain a list or mapping of payment tokens and the transaction tokens to which they correspond. Payment tokens generated by the token generator 532, can allow a commerce application 104a to process a payment without having to comply with regulatory standards, e.g., the PCI DSS standards, as explained below. Alternatively, the transaction token may be a hashed version of the payment token and other information associated with the payment transaction.

As shown by FIG. 5, in one or more embodiments the e-commerce payment facilitator 106a can include a transaction database 534. The transaction database 534 can store details of transactions started and/or completed for each user and/or each commerce application. For example, the e-commerce payment facilitator 106a can track the usage of transaction tokens to provide a detailed status of the payment transaction, including whether the commerce application 104a has received and/or returned the transaction token.

Thus, the transaction database 534 can allow a user to retrieve details on all purchases made with help from the e-commerce payment facilitator 106a. One will appreciate that this can allow a user to login to the network application 200 and retrieve transaction details regarding purchases made on any number of different commerce applications. This provides a significant advantage, as users who do not utilize the e-commerce payment facilitator 106a may need to remember usernames and passwords and login into several commerce applications to get the information and details that the transaction database 534 can provide.

The transaction database 534 can provide for each transaction, attempted or completed, a date, an indication of the commerce application where the transaction was completed, an amount of the transaction, the items/services purchased as part of the transaction (optionally a URL of the open graph product), a status of the transactions (completed, shipped, in progress, returned, denied, etc.), a transaction ID that allows the users to provide to the commerce application to reference the transaction, or other details.

The transaction database 534 can allow users or merchants operating a commerce application to retrieve details regarding transactions, such as a history of transactions including one or more of the transaction details described above. When the network application 200 comprises a social network, the transaction database 534 can provide additional demographic information about the user who purchased items from the commerce application 104a (geographic location of users, age of user, gender of users, etc.) pulled from the social graph.

The embodiment of FIG. 5 also includes a user networking application 536. In an embodiment where the network application 200 comprises a social networking system 520, the user networking application 536 allows the user 102 to utilize the social networking system 520. The user networking application 536 can comprise a native social networking application that runs on a client device. For example, in one or more embodiments the user networking application 536 can comprise a FACEBOOK™ native application. In alternative embodiments, the user networking application 536 might not strictly be for social networking purposes. The user networking application 536 can represent any native application executing on the computing device 502 that allows the user 102 to interact with the network application 200. In one or more embodiments, the user 102 utilizes the user networking application 536 to log in to a social networking system 520, causing the computing device 502 to store an obfuscated user identifier in a portion of shared memory of the computing device 502. This obfuscated user identifier can later be utilized by the commerce application 104a to determine whether the payment information of the user 102 might be able to be used. In one or more embodiments, the user networking application 536 is also utilized by the user to grant or revoke permission for the commerce application 104a to perform payment transactions.

The depicted embodiment also includes a user networking application SDK library 538. The user networking application SDK library 538 provides a set of routines for the commerce application 104a to utilize to interact with the network application 200. In an embodiment, all interaction between the commerce application 104a and the e-commerce payment facilitator 106a flows through the user networking application SDK library 538. In one or more embodiments where at least some of the commerce application 104a executes on a server computing device 514, the server computing device 514 may include a commerce network application SDK library 540 that serves the same purpose, or works in conjunction with, the user networking application SDK library 538.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 6 illustrates a block diagram of exemplary computing device 600 that may be configured to perform one or more of the processes described above. One will appreciate that one or more computing devices such as the computing device 600 may implement the system 100 (e.g., the e-commerce payment facilitator 106, 106a). As shown by FIG. 6, the computing device 600 can comprise a processor 602, a memory 604, a storage device 606, an I/O interface 608, and a communication interface 610, which may be communicatively coupled by way of a communication infrastructure 612. In certain embodiments, the computing device 600 can include fewer or more components than those shown in FIG. 6. Components of the computing device 600 shown in FIG. 6 will now be described in additional detail.

In one or more embodiments, the processor 602 includes hardware for executing instructions, such as those making up a computer program. As an example and not by way of limitation, to execute instructions for dynamically modifying workflows, the processor 602 may retrieve (or fetch) the instructions from an internal register, an internal cache, the memory 604, or the storage device 606 and decode and execute them. The memory 604 may be a volatile or non-volatile memory used for storing data, metadata, and programs for execution by the processor(s). The storage device 606 includes storage, such as a hard disk, flash disk drive, or other digital storage device, for storing data or instructions for performing the methods described herein.

The I/O interface 608 allows a user to provide input to, receive output from, and otherwise transfer data to and receive data from computing device 600. The I/O interface 608 may include a mouse, a keypad or a keyboard, a touch screen, a camera, an optical scanner, network interface, modem, other known I/O devices or a combination of such I/O interfaces. The I/O interface 608 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 608 is configured to provide graphical data to a display for presentation to a user. The graphical data may be representative of one or more graphical user interfaces and/or any other graphical content as may serve a particular implementation.

The communication interface 610 can include hardware, software, or both. In any event, the communication interface 610 can provide one or more interfaces for communication (such as, for example, packet-based communication) between the computing device 600 and one or more other computing devices or networks. As an example and not by way of limitation, the communication interface 610 may include a network interface controller (NIC) or network adapter for communicating with an Ethernet or other wire-based network or a wireless NIC (WNIC) or wireless adapter for communicating with a wireless network, such as a WI-FI.

Additionally, the communication interface 610 may facilitate communications with various types of wired or wireless networks. The communication interface 610 may also facilitate communications using various communication protocols. The communication infrastructure 612 may also include hardware, software, or both that couples components of the computing device 600 to each other. For example, the communication interface 610 may use one or more networks and/or protocols to enable a plurality of computing devices connected by a particular infrastructure to communicate with each other to perform one or more aspects of the processes described herein. To illustrate, the asset and attribute management process can allow a plurality of devices (e.g., a client device and server devices) to exchange information using various communication networks and protocols for sharing information such as assets, attributes, marketing content, and analytics data.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

As mentioned above, the networking application 200, 518 can comprise a social networking system. A social networking system may enable its users (such as persons or organizations) to interact with the system and with each other. The social networking system may, with input from a user, create and store in the social networking system a user profile associated with the user. The user profile may include demographic information, communication-channel information, and information on personal interests of the user. The social networking system may also, with input from a user, create and store a record of relationships of the user with other users of the social networking system, as well as provide services (e.g. wall posts, photo-sharing, on-line calendars and event organization, messaging, games, or advertisements) to facilitate social interaction between or among users. Also, the social networking system may allow users to post photographs and other multimedia content items to a user's profile page (typically known as “wall posts” or “timeline posts”) or in a photo album, both of which may be accessible to other users of the social networking system depending upon the user's configured privacy settings.

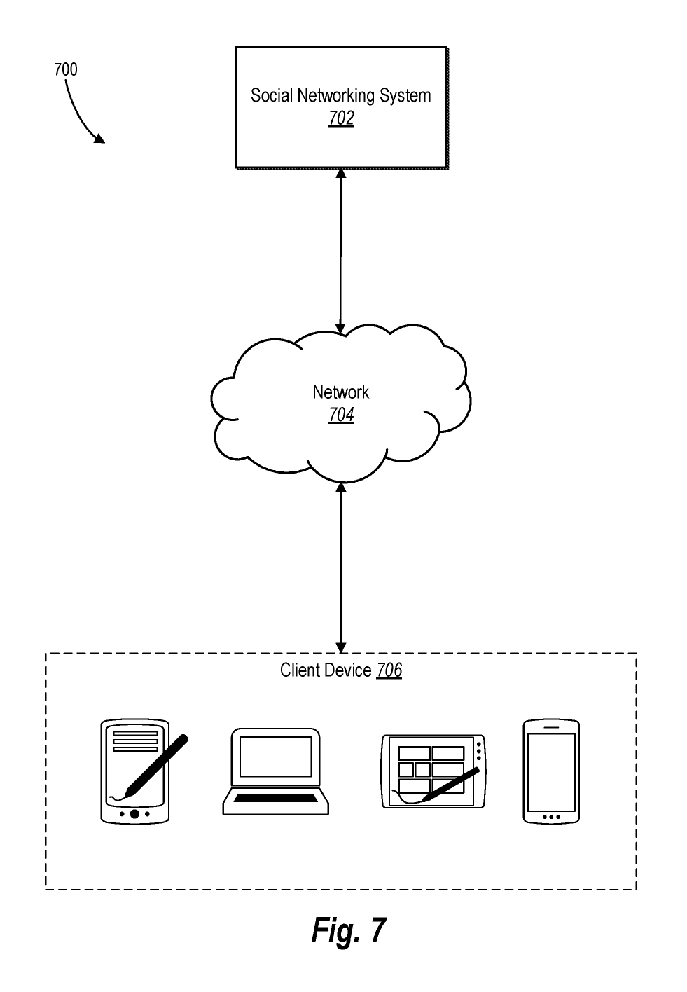

FIG. 7 illustrates an example network environment 700 of a networking system (e.g., social networking system 702). Network environment 700 includes a client system 706 and a social networking system 702 connected to each other by a network 704. Although FIG. 7 illustrates a particular arrangement of client system 706, social networking system 702, and network 704, this disclosure contemplates any suitable arrangement of client system 706, social networking system 702, and network 704. As an example, and not by way of limitation, two or more of client system 706 and social networking system 702 may be connected to each other directly, bypassing network 704. As another example, two or more of client system 706 and social networking system 702 may be physically or logically co-located with each other in whole or in part. Moreover, although FIG. 7 illustrates a particular number of client systems 706, social networking systems 702, and networks 704, this disclosure contemplates any suitable number of client systems 706, social networking systems 702, and networks 704. As an example, and not by way of limitation, network environment 700 may include multiple client system 706, social networking systems 702, and networks 704.

This disclosure contemplates any suitable network 704. As an example, and not by way of limitation, one or more portions of network 704 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 704 may include one or more networks 704.

Links may connect client system 706 and social networking system 702 to communication network 704 or to each other. This disclosure contemplates any suitable links. In particular embodiments, one or more links include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 700. One or more first links may differ in one or more respects from one or more second links.

In particular embodiments, client system 706 may be an electronic device including hardware, software, or embedded logic components or a combination of two or more such components and capable of carrying out the appropriate functionalities implemented or supported by client system 706. As an example, and not by way of limitation, a client system 706 may include any of the computing devices discussed above in relation to FIG. 7. A client system 706 may enable a network user at client system 706 to access network 704. A client system 706 may enable its user to communicate with other users at other client systems 706.

In particular embodiments, client system 706 may include a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 706 may enter a Uniform Resource Locator (URL) or other address directing the web browser to a particular server (such as server, or a server associated with a third-party system), and the web browser may generate a Hyper Text Transfer Protocol (HTTP) request and communicate the HTTP request to server. The server may accept the HTTP request and communicate to client system 706 one or more Hyper Text Markup Language (HTML) files responsive to the HTTP request. Client system 706 may render a webpage based on the HTML files from the server for presentation to the user. This disclosure contemplates any suitable webpage files. As an example, and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social networking system 702 may be a network-addressable computing system that can host an online social network. Social networking system 702 may generate, store, receive, and send social networking data, such as, for example, user-profile data, concept-profile data, social-graph information, or other suitable data related to the online social network. Social networking system 702 may be accessed by the other components of network environment 700 either directly or via network 704. In particular embodiments, social networking system 702 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, social networking system 702 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client system 706, a social networking system 702, or a third-party system to manage, retrieve, modify, add, or delete, the information stored in data store.

In particular embodiments, social networking system 702 may store one or more social graphs in one or more data stores. In particular embodiments, a social graph may include multiple nodes—which may include multiple user nodes (each corresponding to a particular user) or multiple concept nodes (each corresponding to a particular concept)—and multiple edges connecting the nodes. Social networking system 702 may provide users of the online social network the ability to communicate and interact with other users. In particular embodiments, users may join the online social network via social networking system 702 and then add connections (e.g., relationships) to a number of other users of social networking system 702 whom they want to be connected to. Herein, the term “friend” may refer to any other user of social networking system 702 with whom a user has formed a connection, association, or relationship via social networking system 702.

In particular embodiments, social networking system 702 may provide users with the ability to take actions on various types of items or objects, supported by social networking system 702. As an example, and not by way of limitation, the items and objects may include groups or social networks to which users of social networking system 702 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social networking system 702 or by an external system of a third-party system, which is separate from social networking system 702 and coupled to social networking system 702 via a network 704.

In particular embodiments, social networking system 702 may be capable of linking a variety of entities. As an example, and not by way of limitation, social networking system 702 may enable users to interact with each other as well as receive content from third-party systems or other entities, or to allow users to interact with these entities through an application programming interfaces (API) or other communication channels.

In particular embodiments, a third-party system may include one or more types of servers, one or more data stores, one or more interfaces, including but not limited to APIs, one or more web services, one or more content sources, one or more networks, or any other suitable components, e.g., that servers may communicate with. A third-party system may be operated by a different entity from an entity operating social networking system 702. In particular embodiments, however, social networking system 702 and third-party systems may operate in conjunction with each other to provide social networking services to users of social networking system 702. In this sense, social networking system 702 may provide a platform, or backbone, which other systems, such as third-party systems, may use to provide social networking services and functionality to users across the Internet.

In particular embodiments, a third-party system may include a third-party content object provider. A third-party content object provider may include one or more sources of content objects, which may be communicated to a client system 706. As an example, and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social networking system 702 also includes user-generated content objects, which may enhance a user's interactions with social networking system 702. User-generated content may include anything a user can add, upload, send, or “post” to social networking system 702. As an example, and not by way of limitation, a user communicates posts to social networking system 702 from a client system 706. Posts may include data such as status updates or other textual data, location information, photos, videos, links, music or other similar data or media. Content may also be added to social networking system 702 by a third-party through a “communication channel,” such as a newsfeed or stream.

In particular embodiments, social networking system 702 may include a variety of servers, sub-systems, programs, modules, logs, and data stores. In particular embodiments, social networking system 702 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social networking system 702 may also include suitable components such as network interfaces, security mechanisms, load balancers, failover servers, management-and-network-operations consoles, other suitable components, or any suitable combination thereof. In particular embodiments, social networking system 702 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example, and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social networking system 702 to one or more client systems 706 or one or more third-party system via network 704. The web server may include a mail server or other messaging functionality for receiving and routing messages between social networking system 702 and one or more client systems 706. An API-request server may allow a third-party system to access information from social networking system 702 by calling one or more APIs. An action logger may be used to receive communications from a web server about a user's actions on or off social networking system 702. In conjunction with the action log, a third-party-content-object log may be maintained of user exposures to third-party-content objects. A notification controller may provide information regarding content objects to a client system 706. Information may be pushed to a client system 706 as notifications, or information may be pulled from client system 706 responsive to a request received from client system 706. Authorization servers may be used to enforce one or more privacy settings of the users of social networking system 702. A privacy setting of a user determines how particular information associated with a user can be shared. The authorization server may allow users to opt in to or opt out of having their actions logged by social networking system 702 or shared with other systems, such as, for example, by setting appropriate privacy settings. Third-party-content-object stores may be used to store content objects received from third parties, such as a third-party system. Location stores may be used for storing location information received from client systems 706 associated with users. Advertisement-pricing modules may combine social information, the current time, location information, or other suitable information to provide relevant advertisements, in the form of notifications, to a user.

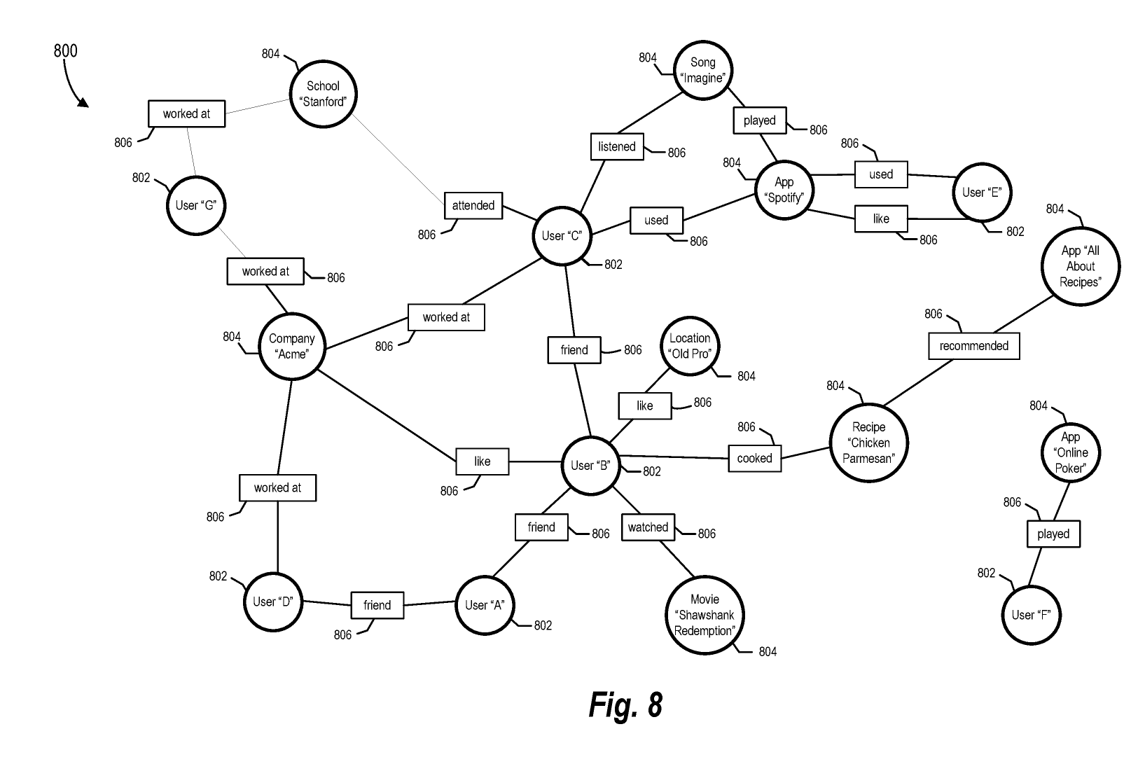

FIG. 8 illustrates example social graph 800. In particular embodiments, social networking system 702 may store one or more social graphs 800 in one or more data stores. In particular embodiments, social graph 800 may include multiple nodes—which may include multiple user nodes 802 or multiple concept nodes 804—and multiple edges 806 connecting the nodes. Example social graph 800 illustrated in FIG. 8 is shown, for didactic purposes, in a two-dimensional visual map representation. In particular embodiments, a social networking system 702, client system 706, or third-party system may access social graph 800 and related social-graph information for suitable applications. The nodes and edges of social graph 800 may be stored as data objects, for example, in a data store (such as a social-graph database). Such a data store may include one or more searchable or query able indexes of nodes or edges of social graph 800.

In particular embodiments, a user node 802 may correspond to a user of social networking system 702. As an example, and not by way of limitation, a user may be an individual (human user), an entity (e.g., an enterprise, business, or third-party application), or a group (e.g., of individuals or entities) that interacts or communicates with or over social networking system 702. In particular embodiments, when a user registers for an account with social networking system 702, social networking system 702 may create a user node 802 corresponding to the user, and store the user node 802 in one or more data stores. Users and user nodes 802 described herein may, where appropriate, refer to registered users and user nodes 802 associated with registered users. In addition, or as an alternative, users and user nodes 802 described herein may, where appropriate, refer to users that have not registered with social networking system 702. In particular embodiments, a user node 802 may be associated with information provided by a user or information gathered by various systems, including social networking system 702. As an example, and not by way of limitation, a user may provide his or her name, profile picture, contact information, birth date, sex, marital status, family status, employment, education background, preferences, interests, or other demographic information. Each user node of the social graph may have a corresponding web page (typically known as a profile page). In response to a request including a user name, the social networking system can access a user node corresponding to the user name, and construct a profile page including the name, a profile picture, and other information associated with the user. A profile page of a first user may display to a second user all or a portion of the first user's information based on one or more privacy settings by the first user and the relationship between the first user and the second user.

In particular embodiments, a concept node 804 may correspond to a concept. As an example and not by way of limitation, a concept may correspond to a place (such as, for example, a movie theater, restaurant, landmark, or city); a website (such as, for example, a website associated with social-network system 702 or a third-party website associated with a web-application server); an entity (such as, for example, a person, business, group, sports team, or celebrity); a resource (such as, for example, an audio file, video file, digital photo, text file, structured document, or application) which may be located within social networking system 702 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 804 may be associated with information of a concept provided by a user or information gathered by various systems, including social networking system 702. As an example, and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 804 may be associated with one or more data objects corresponding to information associated with concept node 804. In particular embodiments, a concept node 804 may correspond to one or more webpages.

In particular embodiments, a node in social graph 800 may represent or be represented by a webpage (which may be referred to as a “profile page”). Profile pages may be hosted by or accessible to social networking system 702. Profile pages may also be hosted on third-party websites associated with a third-party system. As an example, and not by way of limitation, a profile page corresponding to a particular external webpage may be the particular external webpage and the profile page may correspond to a particular concept node 804. Profile pages may be viewable by all or a selected subset of other users. As an example, and not by way of limitation, a user node 802 may have a corresponding user-profile page in which the corresponding user may add content, make declarations, or otherwise express himself or herself. As another example and not by way of limitation, a concept node 804 may have a corresponding concept-profile page in which one or more users may add content, make declarations, or express themselves, particularly in relation to the concept corresponding to concept node 804.

In particular embodiments, a concept node 804 may represent a third-party webpage or resource hosted by a third-party system. The third-party webpage or resource may include, among other elements, content, a selectable or other icon, or other inter-actable object (which may be implemented, for example, in JavaScript, AJAX, or PHP codes) representing an action or activity. As an example, and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client system 706 to send to social networking system 702 a message indicating the user's action. In response to the message, social networking system 702 may create an edge (e.g., an “eat” edge) between a user node 802 corresponding to the user and a concept node 804 corresponding to the third-party webpage or resource and store edge 806 in one or more data stores.

In particular embodiments, a pair of nodes in social graph 800 may be connected to each other by one or more edges 806. An edge 806 connecting a pair of nodes may represent a relationship between the pair of nodes. In particular embodiments, an edge 806 may include or represent one or more data objects or attributes corresponding to the relationship between a pair of nodes. As an example, and not by way of limitation, a first user may indicate that a second user is a “friend” of the first user. In response to this indication, social networking system 702 may send a “friend request” to the second user. If the second user confirms the “friend request,” social networking system 702 may create an edge 806 connecting the first user's user node 802 to the second user's user node 802 in social graph 800 and store edge 806 as social-graph information in one or more of data stores. In the example of FIG. 8, social graph 800 includes an edge 806 indicating a friend relation between user nodes 802 of user “A” and user “B” and an edge indicating a friend relation between user nodes 802 of user “C” and user “B.” Although this disclosure describes or illustrates particular edges 806 with particular attributes connecting particular user nodes 802, this disclosure contemplates any suitable edges 806 with any suitable attributes connecting user nodes 802. As an example, and not by way of limitation, an edge 806 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 800 by one or more edges 806.

In particular embodiments, an edge 806 between a user node 802 and a concept node 804 may represent a particular action or activity performed by a user associated with user node 802 toward a concept associated with a concept node 804. As an example, and not by way of limitation, as illustrated in FIG. 8, a user may “like,” “attended,” “played,” “listened,” “cooked,” “worked at,” or “watched” a concept, each of which may correspond to an edge type or subtype. A concept-profile page corresponding to a concept node 804 may include, for example, a selectable “check in” icon (such as, for example, a clickable “check in” icon) or a selectable “add to favorites” icon. Similarly, after a user clicks these icons, social networking system 702 may create a “favorite” edge or a “check in” edge in response to a user's action corresponding to a respective action. As another example and not by way of limitation, a user (user “C”) may listen to a particular song (“Ramble On”) using a particular application (SPOTIFY, which is an online music application). In this case, social networking system 702 may create a “listened” edge 806 and a “used” edge (as illustrated in FIG. 8) between user nodes 802 corresponding to the user and concept nodes 804 corresponding to the song and application to indicate that the user listened to the song and used the application. Moreover, social networking system 702 may create a “played” edge 806 (as illustrated in FIG. 8) between concept nodes 804 corresponding to the song and the application to indicate that the particular song was played by the particular application. In this case, “played” edge 806 corresponds to an action performed by an external application (SPOTIFY) on an external audio file (the song “Imagine”). Although this disclosure describes particular edges 806 with particular attributes connecting user nodes 802 and concept nodes 804, this disclosure contemplates any suitable edges 806 with any suitable attributes connecting user nodes 802 and concept nodes 804. Moreover, although this disclosure describes edges between a user node 802 and a concept node 804 representing a single relationship, this disclosure contemplates edges between a user node 802 and a concept node 804 representing one or more relationships. As an example, and not by way of limitation, an edge 806 may represent both that a user likes and has used at a particular concept. Alternatively, another edge 806 may represent each type of relationship (or multiples of a single relationship) between a user node 802 and a concept node 804 (as illustrated in FIG. 8 between user node 802 for user “E” and concept node 804 for “SPOTIFY”).

In particular embodiments, social networking system 702 may create an edge 806 between a user node 802 and a concept node 804 in social graph 800. As an example and not by way of limitation, a user viewing a concept-profile page (such as, for example, by using a web browser or a special-purpose application hosted by the user's client system 706) may indicate that he or she likes the concept represented by the concept node 804 by clicking or selecting a “Like” icon, which may cause the user's client system 706 to send to social networking system 702 a message indicating the user's liking of the concept associated with the concept-profile page. In response to the message, social networking system 702 may create an edge 806 between user node 802 associated with the user and concept node 804, as illustrated by “like” edge 806 between the user and concept node 804. In particular embodiments, social networking system 702 may store an edge 806 in one or more data stores. In particular embodiments, an edge 806 may be automatically formed by social networking system 702 in response to a particular user action. As an example, and not by way of limitation, if a first user uploads a picture, watches a movie, or listens to a song, an edge 806 may be formed between user node 802 corresponding to the first user and concept nodes 804 corresponding to those concepts. Although this disclosure describes forming particular edges 806 in particular manners, this disclosure contemplates forming any suitable edges 806 in any suitable manner.

In particular embodiments, an advertisement may be text (which may be HTML-linked), one or more images (which may be HTML-linked), one or more videos, audio, one or more ADOBE FLASH files, a suitable combination of these, or any other suitable advertisement in any suitable digital format presented on one or more webpages, in one or more e-mails, or in connection with search results requested by a user. In addition, or as an alternative, an advertisement may be one or more sponsored stories (e.g., a news-feed or ticker item on social networking system 702). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. As an example, and not by way of limitation, advertisements may be included among the search results of a search-results page, where sponsored content is promoted over non-sponsored content.

In particular embodiments, an advertisement may be requested for display within social networking-system webpages, third-party webpages, or other pages. An advertisement may be displayed in a dedicated portion of a page, such as in a banner area at the top of the page, in a column at the side of the page, in a GUI of the page, in a pop-up window, in a drop-down menu, in an input field of the page, over the top of content of the page, or elsewhere with respect to the page. In addition, or as an alternative, an advertisement may be displayed within an application. An advertisement may be displayed within dedicated pages, requiring the user to interact with or watch the advertisement before the user may access a page or utilize an application. The user may, for example view the advertisement through a web browser.

A user may interact with an advertisement in any suitable manner. The user may click or otherwise select the advertisement. By selecting the advertisement, the user may be directed to (or a browser or other application being used by the user) a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, social networking system 702 may execute or modify a particular action of the user.

An advertisement may also include social networking-system functionality that a user may interact with. As an example, and not by way of limitation, an advertisement may enable a user to “like” or otherwise endorse the advertisement by selecting an icon or link associated with endorsement. As another example and not by way of limitation, an advertisement may enable a user to search (e.g., by executing a query) for content related to the advertiser. Similarly, a user may share the advertisement with another user (e.g., through social networking system 702) or RSVP (e.g., through social networking system 702) to an event associated with the advertisement. In addition, or as an alternative, an advertisement may include social networking-system context directed to the user. As an example, and not by way of limitation, an advertisement may display information about a friend of the user within social networking system 702 who has taken an action associated with the subject matter of the advertisement.

In particular embodiments, social networking system 702 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social networking system 702 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social networking system 702 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example, and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 90% of the overall coefficient, while the relationship between the user and the object may comprise 40% of the overall coefficient. In particular embodiments, the social networking system 702 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example, and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social networking system 702 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social networking system 702 may calculate a coefficient based on a user's actions. Social networking system 702 may monitor such actions on the online social network, on a third-party system, on other suitable systems, or any combination thereof. Any suitable type of user actions may be tracked or monitored. Typical user actions include viewing profile pages, creating or posting content, interacting with content, joining groups, listing and confirming attendance at events, checking-in at locations, liking particular pages, creating pages, and performing other tasks that facilitate social action. In particular embodiments, social networking system 702 may calculate a coefficient based on the user's actions with particular types of content. The content may be associated with the online social network, a third-party system, or another suitable system. The content may include users, profile pages, posts, news stories, headlines, instant messages, chat room conversations, emails, advertisements, pictures, video, music, other suitable objects, or any combination thereof. Social networking system 702 may analyze a user's actions to determine whether one or more of the actions indicate an affinity for subject matter, content, other users, and so forth. As an example, and not by way of limitation, if a user may make frequently posts content related to “coffee” or variants thereof, social networking system 702 may determine the user has a high coefficient with respect to the concept “coffee”. Particular actions or types of actions may be assigned a higher weight and/or rating than other actions, which may affect the overall calculated coefficient. As an example, and not by way of limitation, if a first user emails a second user, the weight or the rating for the action may be higher than if the first user simply views the user-profile page for the second user.

In particular embodiments, social networking system 702 may calculate a coefficient based on the type of relationship between particular objects. Referencing the social graph 800, social networking system 702 may analyze the number and/or type of edges 806 connecting particular user nodes 802 and concept nodes 804 when calculating a coefficient. As an example, and not by way of limitation, user nodes 802 that are connected by a spouse-type edge (representing that the two users are married) may be assigned a higher coefficient than user nodes 802 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example, and not by way of limitation, if a user is tagged in first photo, but merely likes a second photo, social networking system 702 may determine that the user has a higher coefficient with respect to the first photo than the second photo because having a tagged-in-type relationship with content may be assigned a higher weight and/or rating than having a like-type relationship with content. In particular embodiments, social networking system 702 may calculate a coefficient for a first user based on the relationship one or more second users have with a particular object. In other words, the connections and coefficients other users have with an object may affect the first user's coefficient for the object. As an example, and not by way of limitation, if a first user is connected to or has a high coefficient for one or more second users, and those second users are connected to or have a high coefficient for a particular object, social networking system 702 may determine that the first user should also have a relatively high coefficient for the particular object. In particular embodiments, the coefficient may be based on the degree of separation between particular objects. Degree of separation between any two nodes is defined as the minimum number of hops required to traverse the social graph from one node to the other. A degree of separation between two nodes can be considered a measure of relatedness between the users or the concepts represented by the two nodes in the social graph. For example, two users having user nodes that are directly connected by an edge (i.e., are first-degree nodes) may be described as “connected users” or “friends.” Similarly, two users having user nodes that are connected only through another user node (i.e., are second-degree nodes) may be described as “friends of friends.” The lower coefficient may represent the decreasing likelihood that the first user will share an interest in content objects of the user that is indirectly connected to the first user in the social graph 800. As an example, and not by way of limitation, social-graph entities that are closer in the social graph 800 (i.e., fewer degrees of separation) may have a higher coefficient than entities that are further apart in the social graph 800.

In particular embodiments, social networking system 702 may calculate a coefficient based on location information. Objects that are geographically closer to each other may be considered to be more related, or of more interest, to each other than more distant objects. In particular embodiments, the coefficient of a user towards a particular object may be based on the proximity of the object's location to a current location associated with the user (or the location of a client system 706 of the user). A first user may be more interested in other users or concepts that are closer to the first user. As an example, and not by way of limitation, if a user is one mile from an airport and two miles from a gas station, social networking system 702 may determine that the user has a higher coefficient for the airport than the gas station based on the proximity of the airport to the user.

In particular embodiments, social networking system 702 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social networking system 702 may provide information that is relevant to user's interests and current circumstances, increasing the likelihood that they will find such information of interest. In particular embodiments, social networking system 702 may generate content based on coefficient information. Content objects may be provided or selected based on coefficients specific to a user. As an example, and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social networking system 702 may generate search results based on coefficient information. Search results for a particular user may be scored or ranked based on the coefficient associated with the search results with respect to the querying user. As an example, and not by way of limitation, search results corresponding to objects with higher coefficients may be ranked higher on a search-results page than results corresponding to objects having lower coefficients.

In particular embodiments, social networking system 702 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system (e.g., via an API or other communication channel), or from another suitable system. In response to the request, social networking system 702 may calculate the coefficient (or access the coefficient information if it has previously been calculated and stored). In particular embodiments, social networking system 702 may measure an affinity with respect to a particular process. Different processes (both internal and external to the online social network) may request a coefficient for a particular object or set of objects. Social networking system 702 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/642,869, filed 1 Oct. 2012, each of which is incorporated by reference.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example, and not by way of limitation, a user of the online social network may specify privacy settings for a user-profile page identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example, and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example, and not by way of limitation, a particular concept node 804 corresponding to a particular photo may have a privacy setting specifying that the photo may only be accessed by users tagged in the photo and their friends. In particular embodiments, privacy settings may allow users to opt in or opt out of having their actions logged by social networking system 702 or shared with other systems (e.g., third-party system). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers may be authorization/privacy servers for enforcing privacy settings. In response to a request from a user (or other entity) for a particular object stored in a data store, social networking system 702 may send a request to the data store for the object. The request may identify the user associated with the request and may only be sent to the user (or a client system 706 of the user) if the authorization server determines that the user is authorized to access the object based on the privacy settings associated with the object. If the requesting user is not authorized to access the object, the authorization server may prevent the requested object from being retrieved from the data store, or may prevent the requested object from be sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

The foregoing specification is described with reference to specific exemplary embodiments thereof. Various embodiments and aspects of the disclosure are described with reference to details discussed herein, and the accompanying drawings illustrate the various embodiments. The description above and drawings are illustrative and are not to be construed as limiting. Numerous specific details are described to provide a thorough understanding of various embodiments.

The additional or alternative embodiments may be embodied in other specific forms without departing from its spirit or essential characteristics. The described embodiments are to be considered in all respects only as illustrative and not restrictive. The scope of the present disclosure is, therefore, indicated by the appended claims rather than by the foregoing description. All changes that come within the meaning and range of equivalency of the claims are to be embraced within their scope.

What is claimed is:

1. A computer-implemented method, comprising:
receiving, by one or more servers, a request to initiate a payment transaction between a user and a merchant;
calling a third-party tokenization system to obtain a payment token representing a payment authorization number corresponding to the payment transaction;
wrapping, by the one or more servers, the payment token representing the payment authorization number within a transaction token;
sending, by the one or more servers, the transaction token to a merchant system associated with the merchant in connection with the payment transaction;
receiving, from the merchant system, the transaction token in connection with a request to process the payment transaction; and
based on receiving the transaction token:
extracting the payment token; and
initiating, by the one or more servers, the payment transaction by sending the payment token to a payment network associated with the merchant.

2. The computer-implemented method as recited in claim 1, wherein wrapping the payment token representing the payment authorization number within the transaction token comprises mapping a payment amount of the payment transaction and a merchant identifier for the merchant to the transaction token.

3. The computer-implemented method as recited in claim 2, wherein initiating the payment transaction comprises sending the payment amount and the merchant identifier to the payment network associated with the merchant.

4. The computer-implemented method as recited in claim 1, wherein wrapping the payment token representing the payment authorization number within the transaction token comprises mapping a time period in which the transaction token is valid for the payment transaction to the transaction token.

5. The computer-implemented method as recited in claim 4, wherein the time period in which the transaction token is valid is a future time period.

6. The computer-implemented method as recited in claim 1, further comprising:
determining a plurality of third-party tokenization systems associated with the merchant; and
selecting the third-party tokenization system from the plurality of third-party tokenization systems from which to obtain the payment token based one or more characteristics associated with the payment transaction.

7. The computer-implemented method as recited in claim 1, wherein:
the payment token is scoped relative to a first transaction variable; and
further comprising scoping the transaction token relative to a second transaction variable that differs from the first transaction variable.

8. The computer-implemented method as recited in claim 1, wherein:
the third-party tokenization system comprises a payment gateway within the payment network; and
the payment token comprises a gateway payment token.

9. The computer-implemented method as recited in claim 1, wherein wrapping the payment token representing the payment authorization number within the transaction token comprises establishing a mapping between the transaction token and the payment token.

10. The computer-implemented method as recited in claim 9, wherein extracting the payment token comprises determining the payment token based on the mapping between the transaction token and the payment token.

11. The computer-implemented method as recited in claim 9, wherein wrapping the payment token representing the payment authorization number within the transaction token comprises establishing a mapping between the transaction token and payment transaction information for the payment transaction.

12. A system, comprising:
at least one processor; and
a non-transitory computer readable storage medium comprising instructions that, when executed by the at least one processor, cause the system to:
receive a request to initiate a payment transaction between a user and a merchant;
calling a third-party tokenization system to obtain a payment token representing a payment authorization number corresponding to the payment transaction;
wrap the payment token representing the payment authorization number within a transaction token;
send the transaction token to a merchant system associated with the merchant in connection with the payment transaction;
receive, from the merchant system, the transaction token in connection with a request to process the payment transaction; and
based on receiving the transaction token:
extract the payment token; and
initiate the payment transaction by sending the payment token to a payment network associated with the merchant.

13. The system as recited in claim 12, further comprising instructions that, when executed by the at least one processor, cause the system to:
map a payment amount of the payment transaction and a merchant identifier for the merchant to the transaction token; and
initiate the payment transaction by sending the payment amount and the merchant identifier to the payment network associated with the merchant.

14. The system as recited in claim 12, further comprising instructions that, when executed by the at least one processor, cause the system to wrap the payment token representing the payment authorization number within the transaction token by associating a future time period in which the transaction token is valid for the payment transaction.

15. The system as recited in claim 12, further comprising instructions that, when executed by the at least one processor, cause the system to scope the transaction token relative to a first transaction variable that differs from a second transaction variable to which the payment token is scoped.

16. The system as recited in claim 12, further comprising instructions that, when executed by the at least one processor, cause the system to:
wrap the payment token representing the payment authorization number within the transaction token by establishing a mapping between the transaction token and the payment token; and
extract the payment token by determining the payment token based on the mapping between the transaction token and the payment token.

17. A non-transitory computer readable storage medium comprising instructions that, when executed by at least one processor, cause a computer system to:
receive a request to initiate a payment transaction between a user and a merchant;
calling a third-party tokenization system to obtain a payment token representing a payment authorization number corresponding to the payment transaction;
wrap the payment token representing the payment authorization number within a transaction token;
send the transaction token to a merchant system associated with the merchant in connection with the payment transaction;
receive, from the merchant system, the transaction token in connection with a request to process the payment transaction; and
based on receiving the transaction token:
extract the payment token; and
initiate the payment transaction by sending the payment token to a payment network associated with the merchant.

18. The non-transitory computer readable storage medium as recited in claim 17, further comprising instructions that, when executed by the at least one processor, cause the computer system to:
associate the transaction token with a payment amount of the payment transaction, a merchant identifier for the merchant, and a time period in which the transaction token is valid; and
store the payment amount of the payment transaction, the merchant identifier for the merchant, and the time period in which the transaction token is valid with a mapping between the payment token and the transaction token.

19. The non-transitory computer readable storage medium as recited in claim 17, further comprising instructions that, when executed by the at least one processor, cause the computer system to:
determine that the merchant is associated with a plurality of third-party tokenization systems; and
dynamically select the third-party tokenization system from the plurality of third-party tokenization systems, wherein the payment token comprises a gateway token, a network token, or a one-time use token.

20. The non-transitory computer readable storage medium as recited in claim 17, further comprising instructions that, when executed by the at least one processor, cause the computer system to scope the transaction token relative to a first transaction variable that differs from a second transaction variable to which the payment token is scoped.
